(19) United States
(12) Patent Application Publication
(10) Pub. No.: US 2025/0091602 A1
(43) Pub. Date: Mar. 20, 2025

(54) CONNECTIVITY-ASSISTED DRIVE POLICY

(71) Applicant: QUALCOMM Incorporated, San Diego, CA (US)

(72) Inventors: Jean-Philippe MONTEUUIS, Northborough, MA (US); Jonathan PETIT, Wenham, MA (US); Stephen Marc CHAVES, Philadelphia, PA (US); Soumya DAS, San Diego, CA (US); Mohammad NEKOUI, Escondido, CA (US); Mohammad Raashid ANSARI, Saugus, MA (US); Cong CHEN, San Diego, CA (US)

(21) Appl. No.: 18/467,038

(22) Filed: Sep. 14, 2023

(51) Int. Cl. B60W 60/00; H04W 4/40

(52) U.S. Cl. CPC B60W 60/001; H04W 4/40; B60W 2420/403; B60W 2420/408; B60W 2556/45

(57) ABSTRACT

Disclosed are techniques for wireless communication. In an aspect, a first vehicle-to-everything (V2X)-capable vehicle receives, from a second V2X-capable vehicle, one or more V2X messages indicating a driving state of the second V2X-capable vehicle, wherein the driving state comprises a location of the second V2X-capable vehicle, a speed of the second V2X-capable vehicle, a heading of the second V2X vehicle, or any combination thereof, and determines a viable driving trajectory for the first V2X-capable vehicle from a plurality of potential driving trajectories of the first V2X-capable vehicle based, at least in part, on the driving state of the second V2X-capable vehicle.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)) and other technical enhancements.

Leveraging the increased data rates and decreased latency of 5G, among other things, vehicle-to-everything (V2X) communication technologies are being implemented to support autonomous driving applications, such as wireless communications between vehicles, between vehicles and the roadside infrastructure, between vehicles and pedestrians, etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a first vehicle-to-everything (V2X)-capable vehicle includes receiving, from a second V2X-capable vehicle, one or more V2X messages indicating a driving state of the second V2X-capable vehicle, wherein the driving state comprises a location of the second V2X-capable vehicle, a speed of the second V2X-capable vehicle, a heading of the second V2X vehicle, or any combination thereof; and determining a viable driving trajectory for the first V2X-capable vehicle from a plurality of potential driving trajectories of the first V2X-capable vehicle based, at least in part, on the driving state of the second V2X-capable vehicle.

In an aspect, a first vehicle-to-everything (V2X)-capable vehicle includes one or more memories; one or more transceivers; and one or more processors communicatively coupled to the one or more memories and the one or more transceivers, the one or more processors, either alone or in combination, configured to: receive, via the one or more transceivers, from a second V2X-capable vehicle, one or more V2X messages indicating a driving state of the second V2X-capable vehicle, wherein the driving state comprises a location of the second V2X-capable vehicle, a speed of the second V2X-capable vehicle, a heading of the second V2X vehicle, or any combination thereof; and determine a viable driving trajectory for the first V2X-capable vehicle from a plurality of potential driving trajectories of the first V2X-capable vehicle based, at least in part, on the driving state of the second V2X-capable vehicle.

In an aspect, a first vehicle-to-everything (V2X)-capable vehicle includes means for receiving, from a second V2X-capable vehicle, one or more V2X messages indicating a driving state of the second V2X-capable vehicle, wherein the driving state comprises a location of the second V2X-capable vehicle, a speed of the second V2X-capable vehicle, a heading of the second V2X vehicle, or any combination thereof; and means for determining a viable driving trajectory for the first V2X-capable vehicle from a plurality of potential driving trajectories of the first V2X-capable vehicle based, at least in part, on the driving state of the second V2X-capable vehicle.

In an aspect, a non-transitory computer-readable medium stores computer-executable instructions that, when executed by a first vehicle-to-everything (V2X)-capable vehicle, cause the first V2X-capable vehicle to: receive, from a second V2X-capable vehicle, one or more V2X messages indicating a driving state of the second V2X-capable vehicle, wherein the driving state comprises a location of the second V2X-capable vehicle, a speed of the second V2X-capable vehicle, a heading of the second V2X vehicle, or any combination thereof; and determine a viable driving trajectory for the first V2X-capable vehicle from a plurality of potential driving trajectories of the first V2X-capable vehicle based, at least in part, on the driving state of the second V2X-capable vehicle.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to one or more aspects of the disclosure.

FIGS. 2A and 2B illustrate example wireless network structures, according to one or more aspects of the disclosure.

FIG. 3A is a top view of a vehicle employing an integrated radar-camera sensor behind the windshield, according to one or more aspects of the disclosure.

FIG. 3B illustrates an example on-board computer (OBC) architecture, according to one or more aspects of the disclosure.

FIGS. 4A, 4B, and 4C are simplified block diagrams of several sample aspects of components that may be employed in a user equipment (UE), a base station, and a network entity, respectively, and configured to support communications as taught herein.

FIG. 5 is a diagram illustrating an example driving policy pipeline, according to one or more aspects of the disclosure.

FIG. 6 is a diagram illustrating an example drive policy prediction and stochastic planning scenario, according to one or more aspects of the disclosure.

FIGS. 7A and 7B illustrate various scenarios the driving policy engine of an ego vehicle may encounter while performing autonomous or semi-autonomous driving maneuvers, according to one or more aspects of the disclosure.

FIG. 8 is a diagram illustrating trajectory generation in an example driving scenario, according to one or more aspects of the disclosure.

FIG. 9 is a diagram illustrating an example driving scenario in which basic safety messages (BSMs) can be used to prune possible route trajectories, according to one or more aspects of the disclosure.

FIG. 10 is a diagram illustrating an example driving scenario in which collective perception messages (CPMs) can be used to prune possible route trajectories, according to one or more aspects of the disclosure.

FIG. 11 is a diagram illustrating another example driving scenario in which CPMs can be used to prune possible route trajectories, according to one or more aspects of the disclosure.

FIGS. 12A and 12B illustrate an example driving scenario in which maneuver sharing and coordination messages (MSCMs) can be used to prune possible route trajectories, according to one or more aspects of the disclosure.

FIGS. 13A and 13B illustrate an example driving scenario in which decentralized environmental notification messages (DENMs) can be used to prune possible route trajectories, according to one or more aspects of the disclosure.

FIGS. 14A to 14C illustrate an example driving scenario in which various vehicle-to-everything (V2X) messages can be used to prune possible route trajectories, according to one or more aspects of the disclosure.

FIG. 15 is a diagram illustrating an example driving policy pipeline implementing V2X-based trajectory processing, according to one or more aspects of the disclosure.

FIGS. 16 to 20 illustrate example methods of wireless communication, according to one or more aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to a connectivity-assisted drive policy for autonomous or semi-autonomous vehicles. Some aspects more specifically relate to determining viable trajectories for an autonomous or semi-autonomous vehicle based on one or more vehicle-to-everything (V2X) messages received from other V2X-capable vehicles or roadside infrastructure (e.g., roadside units (RSUs)). In some examples, the information received in one or more basic safety messages (BSMs) can be used to determine viable route trajectories. In some examples, the information received in one or more collective perception messages (CPMs) can be used to determine viable route trajectories. In some examples, the information received in one or more maneuver sharing and coordination messages (MSCMs) can be used to determine viable route trajectories. In some examples, the information received in one or more decentralized environmental notification messages (DENMs) can be used to determine viable route trajectories. In some examples, viable trajectories determined based on the information received in one or more BSMs, CPMs, MSCMs, DENMs, or any combination thereof can be shared with other V2X vehicles or roadside infrastructure.

Particular aspects of the subject matter described in this disclosure can be implemented to realize one or more of the following potential advantages. In some examples, by using V2X messages to determine viable trajectories, the described techniques can be used to improve route planning. For example, providing the information from V2X messages to the drive policy enables the drive policy to determine viable trajectories even in the absence of sensing information from perception sensors of the autonomous or semi-autonomous vehicle. In addition, the information can be used to prune non-viable trajectories, thereby improving resource utilization of the drive policy.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE), “vehicle UE” (V-UE), “pedestrian UE” (P-UE), and “base station” are not intended to be specific or otherwise limited to any particular radio access technology (RAT), unless otherwise noted. In general, a UE may be any wireless communication device (e.g., vehicle on-board computer, vehicle navigation device, mobile phone, router, tablet computer, laptop computer, asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as a “mobile device,” an “access terminal” or “AT,” a “client device,” a “wireless device,” a “subscriber device,” a “subscriber terminal,” a “subscriber station,” a “user terminal” or UT, a “mobile terminal,” a “mobile station,” or variations thereof.

A V-UE is a type of UE and may be any in-vehicle wireless communication device, such as a navigation system, a warning system, a heads-up display (HUD), an on-board computer, an in-vehicle infotainment system, an automated driving system (ADS), an advanced driver assistance system (ADAS), etc. Alternatively, a V-UE may be a portable wireless communication device (e.g., a cell phone, tablet computer, etc.) that is carried by the driver of the vehicle or a passenger in the vehicle. The term “V-UE” may refer to the in-vehicle wireless communication device or the vehicle itself, depending on the context. A P-UE is a type of UE and may be a portable wireless communication device that is carried by a pedestrian (i.e., a user that is not driving or riding in a vehicle). Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on Institute of Electrical and Electronics Engineers (IEEE) 802.11, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs including supporting data, voice and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an UL/reverse or DL/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference RF signals to UEs to be measured by the UEs and/or may receive and measure signals transmitted by the UEs. Such base stations may be referred to as positioning beacons (e.g., when transmitting RF signals to UEs) and/or as location measurement units (e.g., when receiving and measuring RF signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

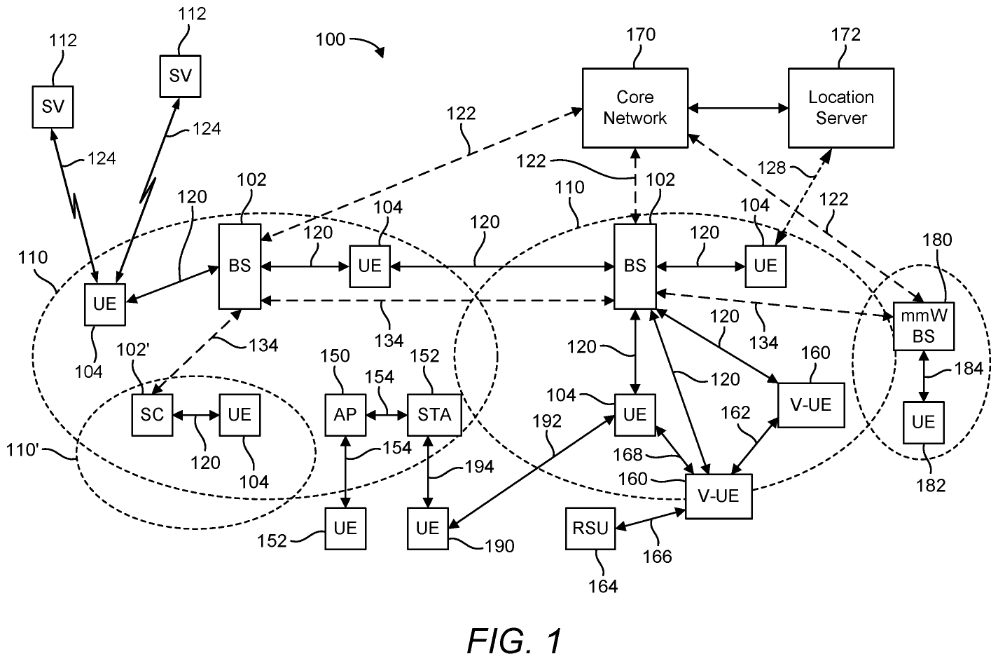

FIG. 1 illustrates an example wireless communications system 100, according to aspects of the disclosure. The wireless communications system 100 (which may also be referred to as a wireless wide area network (WWAN)) may include various base stations 102 (labelled “BS”) and various UEs 104. The base stations 102 may include macro cell base stations (high power cellular base stations) and/or small cell base stations (low power cellular base stations). In an aspect, the macro cell base stations 102 may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both the logical communication entity and the base station that supports it, depending on the context. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labelled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MULTEFIRE®.

The wireless communications system 100 may further include a mmW base station 180 that may operate in millimeter wave (mmW) frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the INTERNATIONAL TELECOMMUNICATION UNION® as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters.

Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

Leveraging the increased data rates and decreased latency of NR, among other things, vehicle-to-everything (V2X) communication technologies are being implemented to support intelligent transportation systems (ITS) applications, such as wireless communications between vehicles (vehicle-to-vehicle (V2V)), between vehicles and the roadside infrastructure (vehicle-to-infrastructure (V2I)), and between vehicles and pedestrians (vehicle-to-pedestrian (V2P)). The goal is for vehicles to be able to sense the environment around them and communicate that information to other vehicles, infrastructure, and personal mobile devices. Such vehicle communication will enable safety, mobility, and environmental advancements that current technologies are unable to provide. Once fully implemented, the technology is expected to reduce unimpaired vehicle crashes by 80%.

Still referring to FIG. 1, the wireless communications system 100 may include multiple V-UEs 160 that may communicate with base stations 102 over communication links 120 using the Uu interface (i.e., the air interface between a UE and a base station). V-UEs 160 may also communicate directly with each other over a wireless sidelink 162, with a roadside unit (RSU) 164 (a roadside access point) over a wireless sidelink 166, or with sidelink-capable UEs 104 over a wireless sidelink 168 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, V2V communication, V2X communication (e.g., cellular V2X (cV2X) communication, enhanced V2X (eV2X) communication, etc.), emergency rescue applications, etc. One or more of a group of V-UEs 160 utilizing sidelink communications may be within the geographic coverage area 110 of a base station 102. Other V-UEs 160 in such a group may be outside the geographic coverage area 110 of a base station 102 or be otherwise unable to receive transmissions from a base station 102. In some cases, groups of V-UEs 160 communicating via sidelink communications may utilize a one-to-many (1:M) system in which each V-UE 160 transmits to every other V-UE 160 in the group. In some cases, a base station 102 facilitates the scheduling of resources for sidelink communications. In other cases, sidelink communications are carried out between V-UEs 160 without the involvement of a base station 102.

In an aspect, the sidelinks 162, 166, 168 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs.

In an aspect, the sidelinks 162, 166, 168 may be cV2X links. A first generation of cV2X has been standardized in LTE, and the next generation is expected to be defined in NR. cV2X is a cellular technology that also enables device-to-device communications. In the U.S. and Europe, cV2X is expected to operate in the licensed ITS band in sub-6 GHZ. Other bands may be allocated in other countries. Thus, as a particular example, the medium of interest utilized by sidelinks 162, 166, 168 may correspond to at least a portion of the licensed ITS frequency band of sub-6 GHZ. However, the present disclosure is not limited to this frequency band or cellular technology.

In an aspect, the sidelinks 162, 166, 168 may be dedicated short-range communications (DSRC) links. DSRC is a one-way or two-way short-range to medium-range wireless communication protocol that uses the wireless access for vehicular environments (WAVE) protocol, also known as IEEE 802.11p, for V2V, V2I, and V2P communications. IEEE 802.11p is an approved amendment to the IEEE 802.11 standard and operates in the licensed ITS band of 5.9 GHZ (5.85-5.925 GHZ) in the U.S. In Europe, IEEE 802.11p operates in the ITS G5A band (5.875-5.905 MHz). Other bands may be allocated in other countries. The V2V communications briefly described above occur on the Safety Channel, which in the U.S. is typically a 10 MHz channel that is dedicated to the purpose of safety. The remainder of the DSRC band (the total bandwidth is 75 MHz) is intended for other services of interest to drivers, such as road rules, tolling, parking automation, etc. Thus, as a particular example, the mediums of interest utilized by sidelinks 162, 166, 168 may correspond to at least a portion of the licensed ITS frequency band of 5.9 GHZ.

Alternatively, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Communications between the V-UEs 160 are referred to as V2V communications, communications between the V-UEs 160 and the one or more RSUs 164 are referred to as V2I communications, and communications between the V-UEs 160 and one or more UEs 104 (where the UEs 104 are P-UEs) are referred to as V2P communications. The V2V communications between V-UEs 160 may include, for example, information about the position, speed, acceleration, heading (e.g., instantaneous trajectory), and other vehicle data of the V-UEs 160. The V2I information received at a V-UE 160 from the one or more RSUs 164 may include, for example, road rules, parking automation information, etc. The V2P communications between a V-UE 160 and a UE 104 may include information about, for example, the position, speed, acceleration, and heading of the V-UE 160 and the position, speed (e.g., where the UE 104 is carried by a user on a bicycle), and heading of the UE 104.

Note that although FIG. 1 only illustrates two of the UEs as V-UEs (V-UEs 160), any of the illustrated UEs (e.g., UEs 104, 152, 182, 190) may be V-UEs. In addition, while only the V-UEs 160 and a single UE 104 have been illustrated as being connected over a sidelink, any of the UEs illustrated in FIG. 1, whether V-UEs, P-UEs, etc., may be capable of sidelink communication. Further, although only UE 182 was described as being capable of beam forming, any of the illustrated UEs, including V-UEs 160, may be capable of beam forming. Where V-UEs 160 are capable of beam forming, they may beam form towards each other (i.e., towards other V-UEs 160), towards RSUs 164, towards other UEs (e.g., UEs 104, 152, 182, 190), etc. Thus, in some cases, V-UEs 160 may utilize beamforming over sidelinks 162, 166, and 168.

The wireless communications system 100 may further include one or more UEs, such as UE 190, that connects indirectly to one or more communication networks via one or more device-to-device (D2D) peer-to-peer (P2P) links. In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WI-FI DIRECT®, BLUETOOTH®, and so on. As another example, the D2D P2P links 192 and 194 may be sidelinks, as described above with reference to sidelinks 162, 166, and 168.

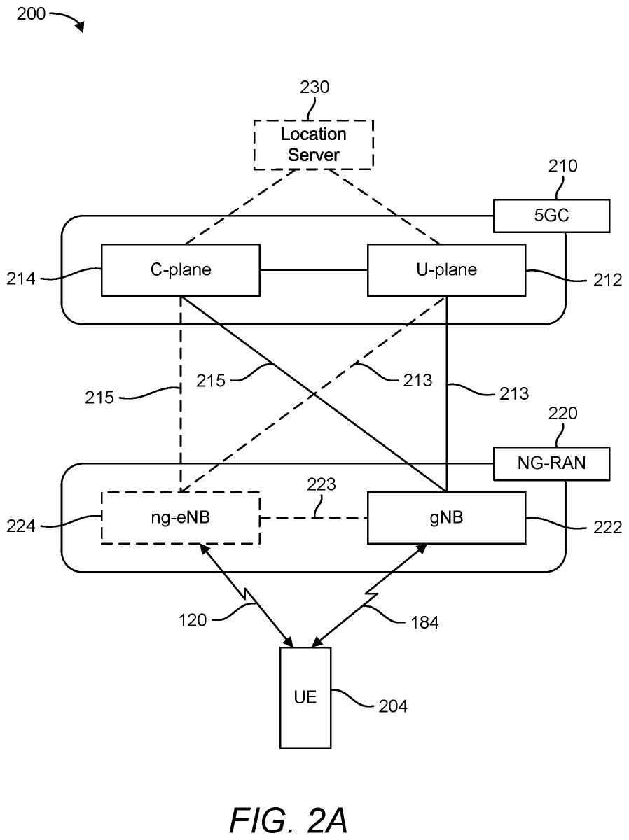

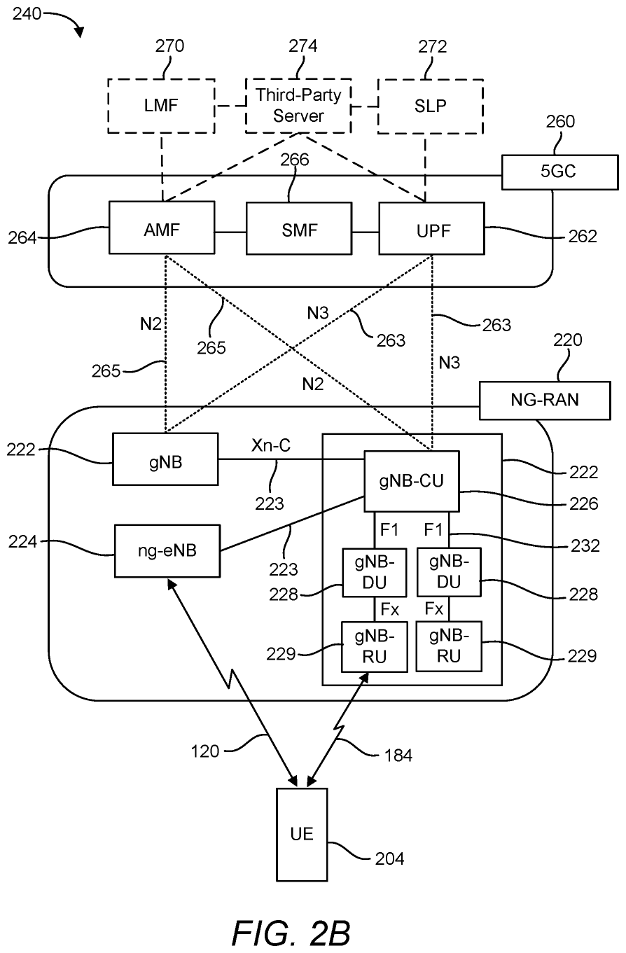

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP® (Third Generation Partnership Project) access networks.

Functions of the UPF 262 include acting as an anchor point for intra/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QOS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

Autonomous and semi-autonomous driving safety technologies use a combination of hardware (sensors, cameras, and radar) and software to help vehicles identify certain safety risks so they can warn the driver to act (in the case of an ADAS), or act themselves (in the case of an ADS), to avoid a crash. A vehicle outfitted with an ADAS or ADS includes one or more camera sensors mounted on the vehicle that capture images of the scene in front of the vehicle, and also possibly behind and to the sides of the vehicle. Radar systems may also be used to detect objects along the road of travel, and also possibly behind and to the sides of the vehicle. Radar systems utilize RF waves to determine the range, direction, speed, and/or altitude of the objects along the road. More specifically, a transmitter transmits pulses of RF waves that bounce off any object(s) in their path. The pulses reflected off the object(s) return a small part of the RF waves' energy to a receiver, which is typically located at the same location as the transmitter. The camera and radar are typically oriented to capture their respective versions of the same scene.

A processor, such as a digital signal processor (DSP), within the vehicle analyzes the captured camera images and radar frames and attempts to identify objects within the captured scene. Such objects may be other vehicles, pedestrians, road signs, objects within the road of travel, etc. The radar system provides reasonably accurate measurements of object distance and velocity in various weather conditions. However, radar systems typically have insufficient resolution to identify features of the detected objects. Camera sensors, however, typically do provide sufficient resolution to identify object features. The cues of object shapes and appearances extracted from the captured images may provide sufficient characteristics for classification of different objects. Given the complementary properties of the two sensors, data from the two sensors can be combined (referred to as “fusion”) in a single system for improved performance.

Modern motor vehicles are increasingly incorporating technology that helps drivers avoid drifting into adjacent lanes or making unsafe lane changes (e.g., lane departure warning (LDW)), or that warns drivers of other vehicles behind them when they are backing up, or that brakes automatically if a vehicle ahead of them stops or slows suddenly (e.g., forward collision warning (FCW)), among other things. The continuing evolution of automotive technology aims to deliver even greater safety benefits, and ultimately deliver automated driving systems (ADS) that can handle the entire task of driving without the need for user intervention.

There are six levels that have been defined to achieve full automation. At Level 0, the human driver does all the driving. At Level 1, an advanced driver assistance system (ADAS) on the vehicle can sometimes assist the human driver with either steering or braking/accelerating, but not both simultaneously. At Level 2, an ADAS on the vehicle can itself actually control both steering and braking/accelerating simultaneously under some circumstances. The human driver must continue to pay full attention at all times and perform the remainder of the driving tasks. At Level 3, an ADS on the vehicle can itself perform all aspects of the driving task under some circumstances. In those circumstances, the human driver must be ready to take back control at any time when the ADS requests the human driver to do so. In all other circumstances, the human driver performs the driving task. At Level 4, an ADS on the vehicle can itself perform all driving tasks and monitor the driving environment, essentially doing all of the driving, in certain circumstances. The human need not pay attention in those circumstances. At Level 5, an ADS on the vehicle can do all the driving in all circumstances. The human occupants are just passengers and need never be involved in driving.

To further enhance ADAS and ADS systems, especially at Level 3 and beyond, autonomous and semi-autonomous vehicles may utilize high definition (HD) map datasets, which contain significantly more detailed information and true-ground-absolute accuracy than those found in current conventional resources. Such HD maps may provide accuracy in the 7-10 cm absolute ranges, highly detailed inventories of all stationary physical assets related to roadways, such as road lanes, road edges, shoulders, dividers, traffic signals, signage, paint markings, poles, and other data useful for the safe navigation of roadways and intersections by autonomous/semi-autonomous vehicles. HD maps may also provide electronic horizon predictive awareness, which enables autonomous/semi-autonomous vehicles to know what lies ahead.

Note that an autonomous or semi-autonomous vehicle may be, but need not be, a V-UE. Likewise, a V-UE may be, but need not be, an autonomous or semi-autonomous vehicle. An autonomous or semi-autonomous vehicle is a vehicle outfitted with an ADAS or ADS. A V-UE is a vehicle with cellular connectivity to a 5G or other cellular network. An autonomous or semi-autonomous vehicle that uses, or is capable of using, cellular techniques for positioning and/or navigation is a V-UE.

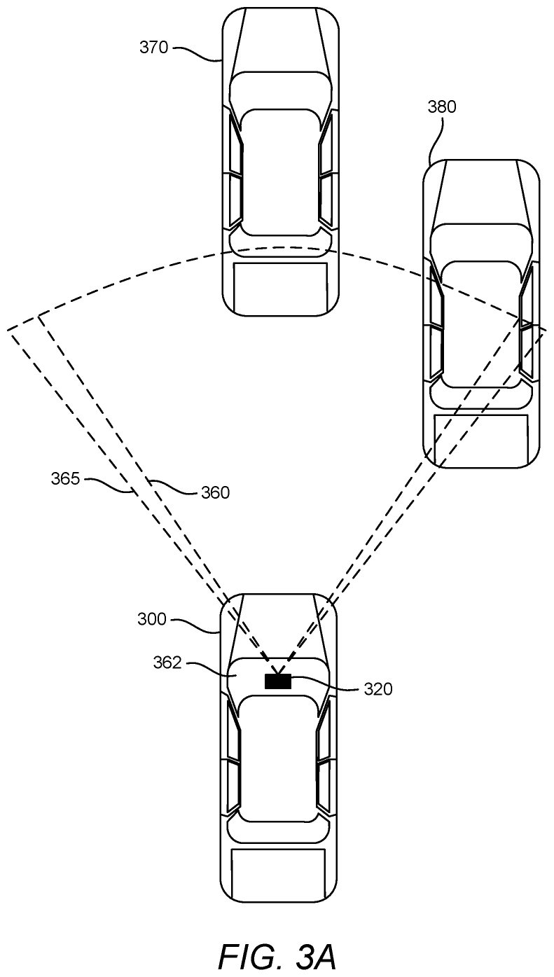

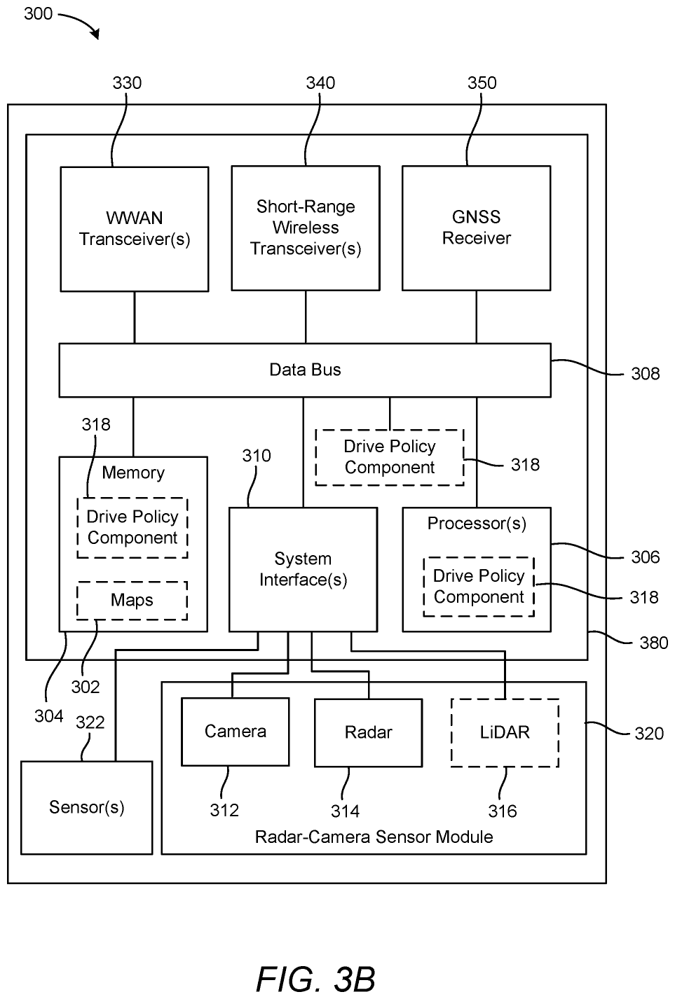

Referring now to FIG. 3A, a V2X-capable vehicle 300 (referred to as an “ego vehicle” or a “host vehicle”) is illustrated that includes a radar-camera sensor module 320 located in the interior compartment of the V2X-capable vehicle 300 behind the windshield 362. The radar-camera sensor module 320 includes a radar component configured to transmit radar signals through the windshield 362 in a horizontal coverage zone 365 (shown by dashed lines), and receive reflected radar signals that are reflected off of any objects within the horizontal coverage zone 365. The radar-camera sensor module 320 further includes a camera component for capturing images based on light waves that are seen and captured through the windshield 362 in a horizontal coverage zone 360 (shown by dashed lines).

Although FIG. 3A illustrates an example in which the radar component and the camera component are co-located components in a shared housing, as will be appreciated, they may be separately housed in different locations within the V2X-capable vehicle 300. For example, the camera may be located as shown in FIG. 3A, and the radar component may be located in the grill or front bumper of the V2X-capable vehicle 300. Additionally, although FIG. 3A illustrates the radar-camera sensor module 320 located behind the windshield 362, it may instead be located in a rooftop sensor array, or elsewhere. Further, although FIG. 3A illustrates only a single radar-camera sensor module 320, as will be appreciated, the V2X-capable vehicle 300 may have multiple radar-camera sensor modules 320 pointed in different directions (to the sides, the front, the rear, etc.). The various radar-camera sensor modules 320 may be under the “skin” of the vehicle (e.g., behind the windshield 362, door panels, bumpers, grills, etc.) or within a rooftop sensor array.

The radar-camera sensor module 320 may detect one or more (or none) objects relative to the V2X-capable vehicle 300. In the example of FIG. 3A, there are two objects, vehicles 370 and 380, within the horizontal coverage zones 360 and 365 that the radar-camera sensor module 320 can detect. The radar-camera sensor module 320 may estimate parameters (attributes) of the detected object(s), such as the position, range, direction, speed, size, classification (e.g., vehicle, pedestrian, road sign, etc.), and the like. The radar-camera sensor module 320 may be employed onboard the V2X-capable vehicle 300 for automotive safety applications, such as adaptive cruise control (ACC), FCW, collision mitigation or avoidance via autonomous braking, LDW, and the like.

Co-locating the camera and radar permits these components to share electronics and signal processing, and in particular, enables early radar-camera data fusion. For example, the radar and camera may be integrated onto a single board. A joint radar-camera alignment technique may be employed to align both the radar and the camera. However, co-location of the radar and camera is not required to practice the techniques described herein.

FIG. 3B illustrates an on-board computer (OBC) 380 of a V2X-capable vehicle 300, according to various aspects of the disclosure. In an aspect, the OBC 380 may be part of an ADAS or ADS. The OBC 380 may also be the V-UE of the V2X-capable vehicle 300. The OBC 380 includes a non-transitory computer-readable storage medium, i.e., memory 304, and one or more processors 306 in communication with the memory 304 via a data bus 308. The memory 304 includes one or more storage modules storing computer-readable instructions executable by the one or more processors 306 to perform the functions of the OBC 380 described herein. For example, the one or more processors 306 in conjunction with the memory 304 may implement the various operations described herein.

One or more radar-camera sensor modules 320 are coupled to the OBC 380 (only one is shown in FIG. 3B for simplicity). In some aspects, the radar-camera sensor module 320 includes at least one camera 312, at least one radar 314, and an optional light detection and ranging (lidar) sensor 316. The OBC 380 also includes one or more system interfaces 310 connecting the one or more processors 306, by way of the data bus 308, to the radar-camera sensor module 320 and, optionally, other vehicle sub-systems (not shown).

The OBC 380 also includes, at least in some cases, one or more wireless wide area network (WWAN) transceivers 330 configured to communicate via one or more wireless communication networks (not shown), such as an NR network, an LTE network, a Global System for Mobile communication (GSM) network, and/or the like. The one or more WWAN transceivers 330 may be connected to one or more antennas (not shown) for communicating with other network nodes, such as other V-UEs, pedestrian UEs, infrastructure access points, roadside units (RSUs), base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The one or more WWAN transceivers 330 may be variously configured for transmitting and encoding signals (e.g., messages, indications, information, and so on), and, conversely, for receiving and decoding signals (e.g., messages, indications, information, pilots, and so on) in accordance with the designated RAT.

The OBC 380 also includes, at least in some cases, one or more short-range wireless transceivers 340 (e.g., a Wi-Fi transceiver, a BLUETOOTH® transceiver, etc.). The one or more short-range wireless transceivers 340 may be connected to one or more antennas (not shown) for communicating with other network nodes, such as other V-UEs, pedestrian UEs, infrastructure access points, RSUs, etc., via at least one designated RAT (e.g., cV2X), IEEE 802.11p (also known as wireless access for vehicular environments (WAVE)), dedicated short-range communication (DSRC), etc.) over a wireless communication medium of interest. The one or more short-range wireless transceivers 340 may be variously configured for transmitting and encoding signals (e.g., messages, indications, information, and so on), and, conversely, for receiving and decoding signals (e.g., messages, indications, information, pilots, and so on) in accordance with the designated RAT.

As used herein, a “transceiver” may include a transmitter circuit, a receiver circuit, or a combination thereof, but need not provide both transmit and receive functionalities in all designs. For example, a low functionality receiver circuit may be employed in some designs to reduce costs when providing full communication is not necessary (e.g., a receiver chip or similar circuitry simply providing low-level sniffing).

The OBC 380 also includes, at least in some cases, a global navigation satellite system (GNSS) receiver 350. The GNSS receiver 350 may be connected to one or more antennas (not shown) for receiving satellite signals. The GNSS receiver 350 may comprise any suitable hardware and/or software for receiving and processing GNSS signals. The GNSS receiver 350 requests information and operations as appropriate from the other systems, and performs the calculations necessary to determine the vehicle's 300 position using measurements obtained by any suitable GNSS algorithm.

In an aspect, the OBC 380 may utilize the one or more WWAN transceivers 330 and/or the one or more short-range wireless transceivers 340 to download one or more maps 302 that can then be stored in memory 304 and used for vehicle navigation. Map(s) 302 may be one or more high definition (HD) maps, which may provide accuracy in the 7-10 cm absolute ranges, highly detailed inventories of all stationary physical assets related to roadways, such as road lanes, road edges, shoulders, dividers, traffic signals, signage, paint markings, poles, and other data useful for the safe navigation of roadways and intersections by the V2X-capable vehicle 300. Map(s) 302 may also provide electronic horizon predictive awareness, which enables the V2X-capable vehicle 300 to know what lies ahead.

The V2X-capable vehicle 300 may include one or more sensors 322 that may be coupled to the one or more processors 306 via the one or more system interfaces 310. The one or more sensors 322 may provide means for sensing or detecting information related to the state and/or environment of the V2X-capable vehicle 300, such as speed, heading (e.g., compass heading), headlight status, gas mileage, etc. By way of example, the one or more sensors 322 may include an odometer a speedometer, a tachometer, an accelerometer (e.g., a micro-electromechanical system-s (MEMS) device), a gyroscope, a geomagnetic sensor (e.g., a compass), an altimeter (e.g., a barometric pressure altimeter), etc. Although shown as located outside the OBC 380, some of these sensors 322 may be located on the OBC 380 and some may be located elsewhere in the V2X-capable vehicle 300.

The OBC 380 may further include a drive policy component 318. The drive policy component 318 may be a hardware circuit that is part of or coupled to the one or more processors 306 that, when executed, causes the OBC 380 to perform the functionality described herein. In other aspects, the drive policy component 318 may be external to the one or more processors 306 (e.g., part of a positioning processing system, integrated with another processing system, etc.). Alternatively, the drive policy component 318 may be one or more memory modules stored in the memory 304 that, when executed by the one or more processors 306 (or positioning processing system, another processing system, etc.), cause the OBC 380 to perform the functionality described herein. As a specific example, the drive policy component 318 may comprise a plurality of positioning engines, a positioning engine aggregator, a sensor fusion module, and/or the like. FIG. 3B illustrates possible locations of the drive policy component 318, which may be, for example, part of the memory 304, the one or more processors 306, or any combination thereof, or may be a standalone component.

In an aspect, the camera 312 may capture image frames (also referred to herein as camera frames) of the scene within the viewing area of the camera 312 (as illustrated in FIG. 3A as horizontal coverage zone 360) at some periodic rate. Likewise, the radar 314 may capture radar frames of the scene within the viewing area of the radar 314 (as illustrated in FIG. 3A as horizontal coverage zone 365) at some periodic rate. The periodic rates at which the camera 312 and the radar 314 capture their respective frames may be the same or different. Each camera and radar frame may be timestamped. Thus, where the periodic rates are different, the timestamps can be used to select simultaneously, or nearly simultaneously, captured camera and radar frames for further processing (e.g., fusion).

For convenience, the OBC 380 is shown in FIG. 3B as including various components that may be configured according to the various examples described herein. It will be appreciated, however, that the illustrated components may have different functionality in different designs. In particular, various components in FIG. 3B are optional in alternative configurations and the various aspects include configurations that may vary due to design choice, costs, use of the device, or other considerations. For brevity, illustration of the various alternative configurations is not provided herein, but would be readily understandable to one skilled in the art.

The components of FIG. 3B may be implemented in various ways. In some implementations, the components of FIG. 3B may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 302 to 350 may be implemented by processor and memory component(s) of the OBC 380 (e.g., by execution of appropriate code and/or by appropriate configuration of processor components). For simplicity, various operations, acts, and/or functions are described herein as being performed “by a UE,” “by an OBC,” or “by a vehicle.” However, as will be appreciated, such operations, acts, and/or functions may actually be performed by specific components or combinations of components of the OBC 380, such as the one or more processors 306, the one or more transceivers 330 and 340, the memory 304, the drive policy component 318, etc.

In an autonomous or semi-autonomous driving scenario, the ego vehicle needs to make various driving decisions, such when to change lanes (e.g., to avoid obstacles, move to an exit lane, etc.), where to merge into traffic, whether to pass another vehicle, and the like. These types of decisions are referred to as “driving policy” or “drive policy” and may be executed by the OBC 380 (e.g., the one or more processors 306, drive policy component 318, memory 304, etc.) based on information from the radar-camera sensor module 320 and/or sensor(s) 322.

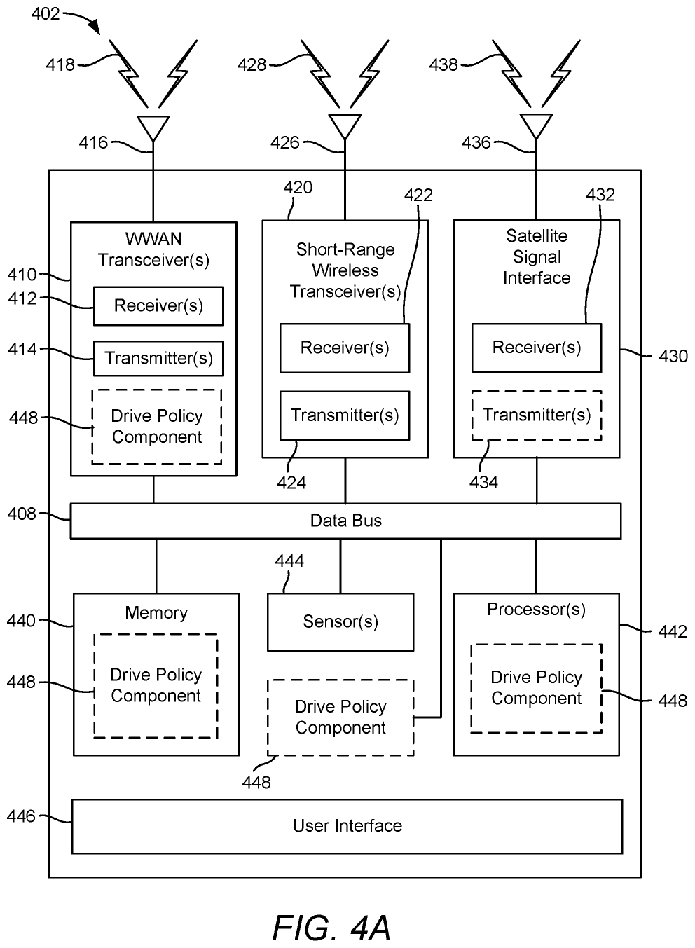

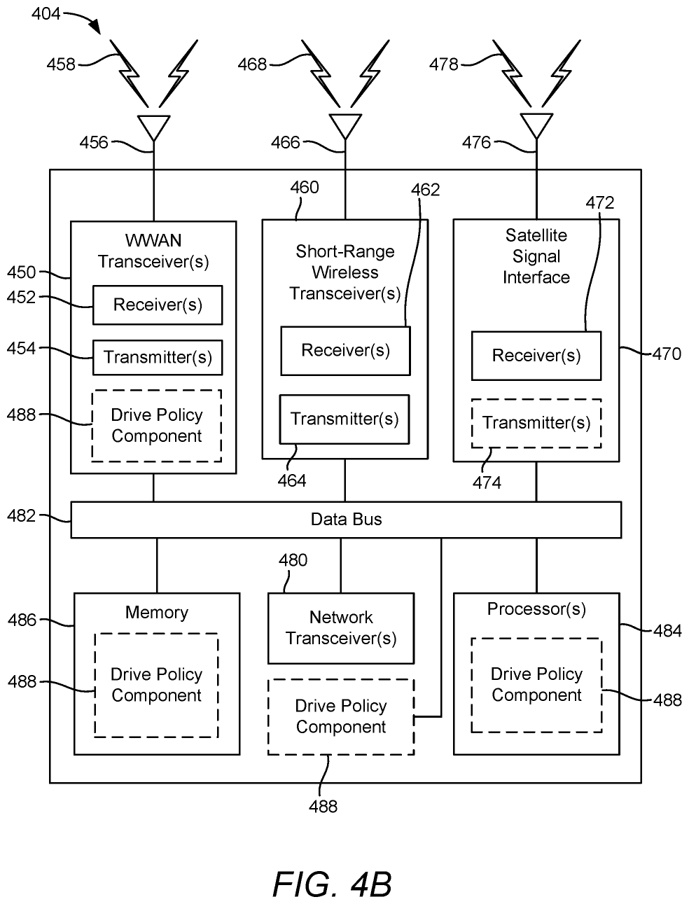

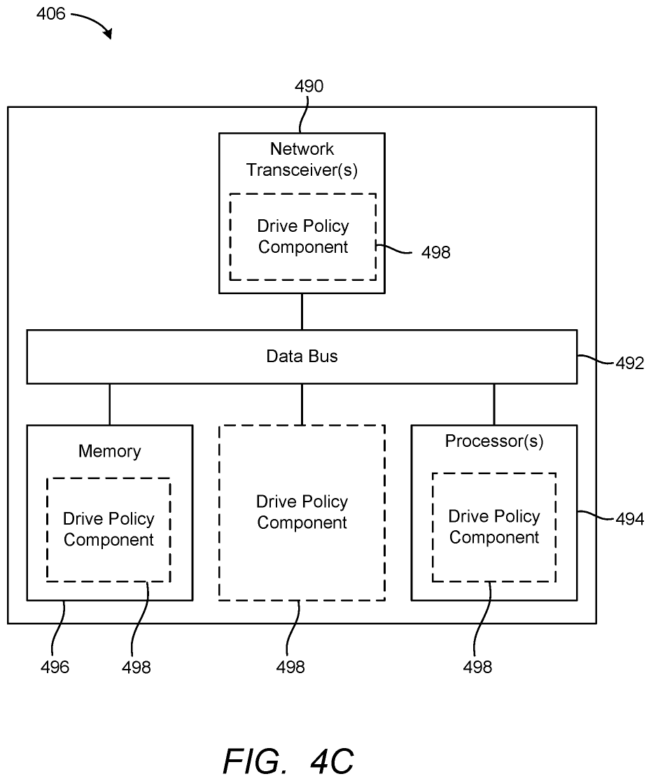

FIGS. 4A, 4B, and 4C illustrate several example components (represented by corresponding blocks) that may be incorporated into a UE 402 (which may correspond to any of the UEs described herein, such as V2X-capable vehicle 300, OBC 380, etc.), a base station 404 (which may correspond to any of the base stations or RSUs described herein), and a network entity 406 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 402 and the base station 404 each include one or more WWAN transceivers 410 and 450, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 410 and 450 may each be connected to one or more antennas 416 and 456, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 410 and 450 may be variously configured for transmitting and encoding signals 418 and 458 (e.g., messages, indications, information, and so on), respectively, and, conversely, for receiving and decoding signals 418 and 458 (e.g., messages, indications, information, pilots, and so on), respectively, in accordance with the designated RAT. Specifically, the WWAN transceivers 410 and 450 include one or more transmitters 414 and 454, respectively, for transmitting and encoding signals 418 and 458, respectively, and one or more receivers 412 and 452, respectively, for receiving and decoding signals 418 and 458, respectively.

The UE 402 and the base station 404 each also include, at least in some cases, one or more short-range wireless transceivers 420 and 460, respectively. The short-range wireless transceivers 420 and 460 may be connected to one or more antennas 426 and 466, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi, LTE Direct, BLUETOOTH®, ZIGBEE®, Z-WAVE®, PC5, dedicated short-range communications (DSRC), wireless access for vehicular environments (WAVE), near-field communication (NFC), ultra-wideband (UWB), etc.) over a wireless communication medium of interest. The short-range wireless transceivers 420 and 460 may be variously configured for transmitting and encoding signals 428 and 468 (e.g., messages, indications, information, and so on), respectively, and, conversely, for receiving and decoding signals 428 and 468 (e.g., messages, indications, information, pilots, and so on), respectively, in accordance with the designated RAT. Specifically, the short-range wireless transceivers 420 and 460 include one or more transmitters 424 and 464, respectively, for transmitting and encoding signals 428 and 468, respectively, and one or more receivers 422 and 462, respectively, for receiving and decoding signals 428 and 468, respectively. As specific examples, the short-range wireless transceivers 420 and 460 may be Wi-Fi transceivers, BLUETOOTH® transceivers, ZIGBEE® and/or Z-WAVE® transceivers, NFC transceivers, UWB transceivers, or vehicle-to-vehicle (V2V) and/or vehicle-to-everything (V2X) transceivers.

The UE 402 and the base station 404 also include, at least in some cases, satellite signal interfaces 430 and 470, which each include one or more satellite signal receivers 432 (e.g., GNSS receiver 350) and 472, respectively, and may optionally include one or more satellite signal transmitters 434 and 474, respectively. In some cases, the base station 404 may be a terrestrial base station that may communicate with space vehicles (e.g., space vehicles 112) via the satellite signal interface 470. In other cases, the base station 404 may be a space vehicle (or other non-terrestrial entity) that uses the satellite signal interface 470 to communicate with terrestrial networks and/or other space vehicles.

The satellite signal receivers 432 and 472 may be connected to one or more antennas 436 and 476, respectively, and may provide means for receiving and/or measuring satellite positioning/communication signals 438 and 478, respectively. Where the satellite signal receiver(s) 432 and 472 are satellite positioning system receivers, the satellite positioning/communication signals 438 and 478 may be global positioning system (GPS) signals, global navigation satellite system (GLONASS) signals, Galileo signals, Beidou signals, Indian Regional Navigation Satellite System (NAVIC), Quasi-Zenith Satellite System (QZSS) signals, etc. Where the satellite signal receiver(s) 432 and 472 are non-terrestrial network (NTN) receivers, the satellite positioning/communication signals 438 and 478 may be communication signals (e.g., carrying control and/or user data) originating from a 5G network. The satellite signal receiver(s) 432 and 472 may comprise any suitable hardware and/or software for receiving and processing satellite positioning/communication signals 438 and 478, respectively. The satellite signal receiver(s) 432 and 472 may request information and operations as appropriate from the other systems, and, at least in some cases, perform calculations to determine locations of the UE 402 and the base station 404, respectively, using measurements obtained by any suitable satellite positioning system algorithm.

The optional satellite signal transmitter(s) 434 and 474, when present, may be connected to the one or more antennas 436 and 476, respectively, and may provide means for transmitting satellite positioning/communication signals 438 and 478, respectively. Where the satellite signal transmitter(s) 474 are satellite positioning system transmitters, the satellite positioning/communication signals 478 may be GPS signals, GLONASS® signals, Galileo signals, Beidou signals, NAVIC, QZSS signals, etc. Where the satellite signal transmitter(s) 434 and d 474 are NTN transmitters, the satellite positioning/communication signals 438 and 478 may be communication signals (e.g., carrying control and/or user data) originating from a 5G network. The satellite signal transmitter(s) 434 and 474 may comprise any suitable hardware and/or software for transmitting satellite positioning/communication signals 438 and 478, respectively. The satellite signal transmitter(s) 434 and 474 may request information and operations as appropriate from the other systems.

The base station 404 and the network entity 406 each include one or more network transceivers 480 and 490, respectively, providing means for communicating (e.g., means for transmitting, means for receiving, etc.) with other network entities (e.g., other base stations 404, other network entities 406). For example, the base station 404 may employ the one or more network transceivers 480 to communicate with other base stations 404 or network entities 406 over one or more wired or wireless backhaul links. As another example, the network entity 406 may employ the one or more network transceivers 490 to communicate with one or more base station 404 over one or more wired or wireless backhaul links, or with other network entities 406 over one or more wired or wireless core network interfaces.

A transceiver may be configured to communicate over a wired or wireless link. A transceiver (whether a wired transceiver or a wireless transceiver) includes transmitter circuitry (e.g., transmitters 414, 424, 454, 464) and receiver circuitry (e.g., receivers 412, 422, 452, 462). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 480 and 490 in some implementations) may be coupled to one or more wired network interface ports. Wireless transmitter circuitry (e.g., transmitters 414, 424, 454, 464) may include or be coupled to a plurality of antennas (e.g., antennas 416, 426, 456, 466), such as an antenna array, that permits the respective apparatus (e.g., UE 402, base station 404) to perform transmit “beamforming,” as described herein. Similarly, wireless receiver circuitry (e.g., receivers 412, 422, 452, 462) may include or be coupled to a plurality of antennas (e.g., antennas 416, 426, 456, 466), such as an antenna array, that permits the respective apparatus (e.g., UE 402, base station 404) to perform receive beamforming, as described herein. In an aspect, the transmitter circuitry and receiver circuitry may share the same plurality of antennas (e.g., antennas 416, 426, 456, 466), such that the respective apparatus can only receive or transmit at a given time, not both at the same time. A wireless transceiver (e.g., WWAN transceivers 410 and 450, short-range wireless transceivers 420 and 460) may also include a network listen module (NLM) or the like for performing various measurements.

As used herein, the various wireless transceivers (e.g., transceivers 410, 420, 450, and 460, and network transceivers 480 and 490 in some implementations) and wired transceivers (e.g., network transceivers 480 and 490 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 402) and a base station (e.g., base station 404) will generally relate to signaling via a wireless transceiver.

The UE 402, the base station 404, and the network entity 406 also include other components that may be used in conjunction with the operations as disclosed herein. The UE 402, the base station 404, and the network entity 406 include one or more processors 442, 484, and 494, respectively, for providing functionality relating to, for example, wireless communication, and for providing other processing functionality. The processors 442, 484, and 494 may therefore provide means for processing, such as means for determining, means for calculating, means for receiving, means for transmitting, means for indicating, etc. In an aspect, the processors 442, 484, and 494 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 402, the base station 404, and the network entity 406 include memory circuitry implementing memories 440, 486, and 496 (e.g., each including a memory device), respectively, for maintaining information (e.g., information indicative of reserved resources, thresholds, parameters, and so on). The memories 440, 486, and 496 may therefore provide means for storing, means for retrieving, means for maintaining, etc. In some cases, the UE 402, the base station 404, and the network entity 406 may include drive policy component 448 (which may correspond to drive policy component 318), 488, and 498, respectively. The drive policy component 448, 488, and 498 may be hardware circuits that are part of or coupled to the processors 442, 484, and 494, respectively, that, when executed, cause the UE 402, the base station 404, and the network entity 406 to perform the functionality described herein. In other aspects, the drive policy component 448, 488, and 498 may be external to the processors 442, 484, and 494 (e.g., part of a modem processing system, integrated with another processing system, etc.).

Alternatively, the drive policy component 448, 488, and 498 may be memory modules stored in the memories 440, 486, and 496, respectively, that, when executed by the processors 442, 484, and 494 (or a modem processing system, another processing system, etc.), cause the UE 402, the base station 404, and the network entity 406 to perform the functionality described herein. FIG. 4A illustrates possible locations of the drive policy component 448, which may be, for example, part of the one or more WWAN transceivers 410, the memory 440, the one or more processors 442, or any combination thereof, or may be a standalone component. FIG. 4B illustrates possible locations of the drive policy component 488, which may be, for example, part of the one or more WWAN transceivers 450, the memory 486, the one or more processors 484, or any combination thereof, or may be a standalone component. FIG. 4C illustrates possible locations of the drive policy component 498, which may be, for example, part of the one or more network transceivers 490, the memory 496, the one or more processors 494, or any combination thereof, or may be a standalone component.

The UE 402 may include one or more sensors 444 coupled to the one or more processors 442 to provide means for sensing or detecting movement and/or orientation information that is independent of motion data derived from signals received by the one or more WWAN transceivers 410, the one or more short-range wireless transceivers 420, and/or the satellite signal interface 430. By way of example, the sensor(s) 444 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 444 may include a plurality of different types of devices and combine their outputs in order to provide motion information. For example, the sensor(s) 444 may use a combination of a multi-axis accelerometer and orientation sensors to provide the ability to compute positions in two-dimensional (2D) and/or three-dimensional (3D) coordinate systems.

In addition, the UE 402 includes a user interface 446 providing means for providing indications (e.g., audible and/or visual indications) to a user and/or for receiving user input (e.g., upon user actuation of a sensing device such a keypad, a touch screen, a microphone, and so on). Although not shown, the base station 404 and the network entity 406 may also include user interfaces.

Referring to the one or more processors 484 in more detail, in the downlink, IP packets from the network entity 406 may be provided to the processor 484. The one or more processors 484 may implement functionality for an RRC layer, a packet data convergence protocol (PDCP) layer, a radio link control (RLC) layer, and a medium access control (MAC) layer. The one or more processors 484 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 454 and the receiver 452 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 454 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 402. Each spatial stream may then be provided to one or more different antennas 456. The transmitter 454 may modulate an RF carrier with a respective spatial stream for transmission.

At the UE 402, the receiver 412 receives a signal through its respective antenna(s) 416. The receiver 412 recovers information modulated onto an RF carrier and provides the information to the one or more processors 442. The transmitter 414 and the receiver 412 implement Layer-1 functionality associated with various signal processing functions. The receiver 412 may perform spatial processing on the information to recover any spatial streams destined for the UE 402. If multiple spatial streams are destined for the UE 402, they may be combined by the receiver 412 into a single OFDM symbol stream. The receiver 412 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 404. These soft decisions may be based on channel estimates computed by a channel estimator. The soft decisions are then decoded and de-interleaved to recover the data and control signals that were originally transmitted by the base station 404 on the physical channel. The data and control signals are then provided to the one or more processors 442, which implements Layer-3 (L3) and Layer-2 (L2) functionality.

In the downlink, the one or more processors 442 provides demultiplexing between transport and logical channels, packet reassembly, deciphering, header decompression, and control signal processing to recover IP packets from the core network. The one or more processors 442 are also responsible for error detection.

Similar to the functionality described in connection with the downlink transmission by the base station 404, the one or more processors 442 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 404 may be used by the transmitter 414 to select the appropriate coding and modulation schemes, and to facilitate spatial processing. The spatial streams generated by the transmitter 414 may be provided to different antenna(s) 416. The transmitter 414 may modulate an RF carrier with a respective spatial stream for transmission.

The uplink transmission is processed at the base station 404 in a manner similar to that described in connection with the receiver function at the UE 402. The receiver 452 receives a signal through its respective antenna(s) 456. The receiver 452 recovers information modulated onto an RF carrier and provides the information to the one or more processors 484.

In the uplink, the one or more processors 484 provides demultiplexing between transport and logical channels, packet reassembly, deciphering, header decompression, control signal processing to recover IP packets from the UE 402. IP packets from the one or more processors 484 may be provided to the core network. The one or more processors 484 are also responsible for error detection.

For convenience, the UE 402, the base station 404, and/or the network entity 406 are shown in FIGS. 4A, 4B, and 4C as including various components that may be configured according to the various examples described herein. It will be appreciated, however, that the illustrated components may have different functionality in different designs. In particular, various components in FIGS. 4A to 4C are optional in alternative configurations and the various aspects include configurations that may vary due to design choice, costs, use of the device, or other considerations. For example, in case of FIG. 4A, a particular implementation of UE 402 may omit the WWAN transceiver(s) 410 (e.g., a wearable device or tablet computer or personal computer (PC) or laptop may have Wi-Fi and/or BLUETOOTH® capability without cellular capability), or may omit the short-range wireless transceiver(s) 420 (e.g., cellular-only, etc.), or may omit the satellite signal interface 430, or may omit the sensor(s) 444, and so on. In another example, in case of FIG. 4B, a particular implementation of the base station 404 may omit the WWAN transceiver(s) 450 (e.g., a Wi-Fi “hotspot” access point without cellular capability), or may omit the short-range wireless transceiver(s) 460 (e.g., cellular-only, etc.), or may omit the satellite signal interface 470, and so on. For brevity, illustration of the various alternative configurations is not provided herein, but would be readily understandable to one skilled in the art.

The various components of the UE 402, the base station 404, and the network entity 406 may be communicatively coupled to each other over data buses 408, 482, and 492, respectively. In an aspect, the data buses 408, 482, and 492 may form, or be part of, a communication interface of the UE 402, the base station 404, and the network entity 406, respectively. For example, where different logical entities are embodied in the same device (e.g., gNB and location server functionality incorporated into the same base station 404), the data buses 408, 482, and 492 may provide communication between them.

The components of FIGS. 4A, 4B, and 4C may be implemented in various ways. In some implementations, the components of FIGS. 4A, 4B, and 4C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 410 to 446 may be implemented by processor and memory component(s) of the UE 402 (e.g., by execution of appropriate code and/or by appropriate configuration of processor components). Similarly, some or all of the functionality represented by blocks 450 to 488 may be implemented by processor and memory component(s) of the base station 404 (e.g., by execution of appropriate code and/or by appropriate configuration of processor components). Also, some or all of the functionality represented by blocks 490 to 498 may be implemented by processor and memory component(s) of the network entity 406 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 402, base station 404, network entity 406, etc., such as the processors 442, 484, 494, the transceivers 410, 420, 450, and 460, the memories 440, 486, and 496, the drive policy component 448, 488, and 498, etc.

In some designs, the network entity 406 may be implemented as a core network component. In other designs, the network entity 406 may be distinct from a network operator or operation of the cellular network infrastructure (e.g., NG RAN 220 and/or 5GC 210/260). For example, the network entity 406 may be a component of a private network that may be configured to communicate with the UE 402 via the base station 404 or independently from the base station 404 (e.g., over a non-cellular communication link, such as Wi-Fi).

Driving policy involves trajectory prediction and route planning functionality. Trajectory prediction follows a data-driven approach that incorporates blinker state information, brake light state information, and trajectory history of other vehicles (referred to as “agents”) around the ego vehicle, along with map geometry (e.g., from maps 302). A graph-based neural network learns multi-agent interactions, while a weighted, multi-modal distribution of trajectories represents the uncertainty in agent intentions and motion. Stochastic predicted trajectories are used in tree search and dynamic programming optimizers for risk-minimizing ego maneuvers. Note that a tree search is only one method, but trajectory prediction could also be performed using a graph-based neural network, where the weightings of the neural network can be updated to adjust which trajectories/paths are still viable.

Route planning attempts to understand the probabilistic evolution of the world through the exploration of belief space. Ego actions are defined through the generation of possible trajectories and agent actions through prediction input. Route planning efficiently prunes the search space (e.g., a search tree) and evaluates candidate trajectories for risk and reward. The output is the coarse reference trajectory along with a corresponding belief of the world and relevant semantics.

Note that a driving trajectory is not necessarily a single driving maneuver (e.g., a lane change, braking, merging, etc.), but rather, is a driving path that may be taken that may be several seconds to minutes into the future. A driving trajectory may therefore include one or more planned driving maneuvers over a time period of several seconds to several minutes into the future.

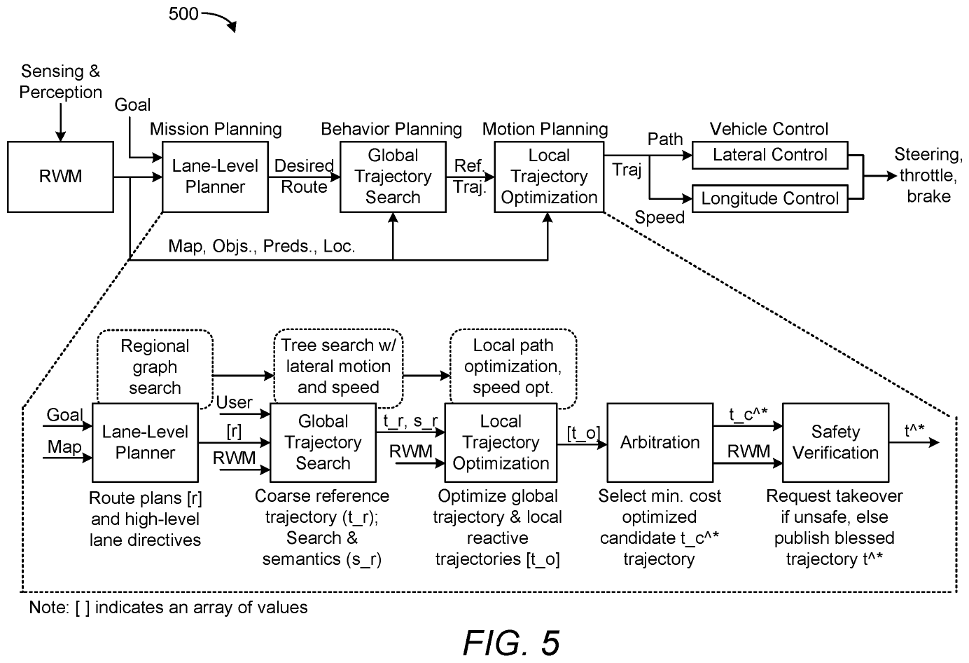

FIG. 5 is a diagram 500 illustrating an example driving policy pipeline, according to aspects of the disclosure. As shown in FIG. 5, at a high level, sensing and perception information (e.g., from camera(s) 312, radar(s) 314, lidar sensor 316, sensor(s) 322) is fed into a real-world model (RWM) block, which outputs map data (e.g., from map(s) 302), object detection results (e.g., of both fixed and moving objects), trajectory predictions of detected moving objects, and the location of the vehicle to a lane-level planner block, a global trajectory search block, and a local trajectory optimization block.

The lane-level planner block takes at least the map data from the RWM block, as well as the driving goal (e.g., change lanes, merge, pass, etc.), and outputs the desired route plan [r] and high-level lane directives to the global trajectory search block. The global trajectory search block generates a set of coarse reference trajectories (denoted t_r) and a set of search and semantics parameters s_r based on the desired route plan [r] and the information from the RWM block. The global trajectory search block outputs t_r and s_r to the local trajectory optimization block, which, based on the information from the RWM block, optimizes the set of coarse reference trajectories t_r and local reactive trajectories to determine a set of optimized trajectories [t_o].

An arbitration block (e.g., within the local trajectory optimization block) selects the minimum cost candidate trajectory t_c\hat{ }* from the set of optimized trajectories [t_o] received from the local trajectory optimization block. The arbitration block outputs the minimum cost candidate trajectory t_c\hat{ }* to a safety verification block (e.g., within the local trajectory optimization block), which verifies the safety of the minimum cost candidate trajectory t_c\hat{ }* and, if safe, outputs the candidate trajectory t_c\hat{ }* as a final “blessed” trajectory t\hat{ }* to a lateral control block and a speed for the trajectory t\hat{ }* to a longitude control block. Based on these inputs, the lateral control block and the longitude control block output steering, throttle, and brake control signals to the respective vehicle systems.

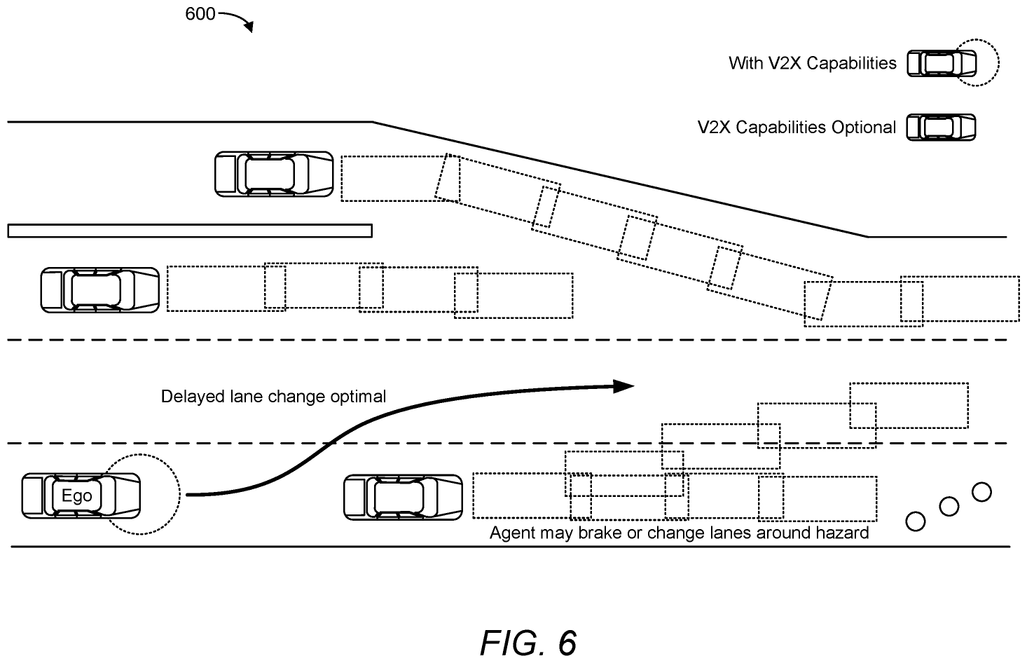

FIG. 6 is a diagram 600 illustrating an example drive policy prediction and stochastic planning scenario, according to aspects of the disclosure. As shown in FIG. 6, an ego vehicle traveling on a three-lane highway intends to perform a lane change. In addition, there is a vehicle to the left of the ego vehicle, a vehicle in the same lane in front of the ego vehicle, and a vehicle merging onto the highway from the left. The vehicle in front of the ego vehicle is approaching a road hazard and will either need to brake or change lanes to avoid the hazard. In addition, the vehicle to the left of the ego vehicle may need to complete a lane change due to the vehicle merging onto the highway. The driving policy of the ego vehicle needs to account for all these possibilities. However, this is computationally expensive, and as such, it would be beneficial to reduce this burden.

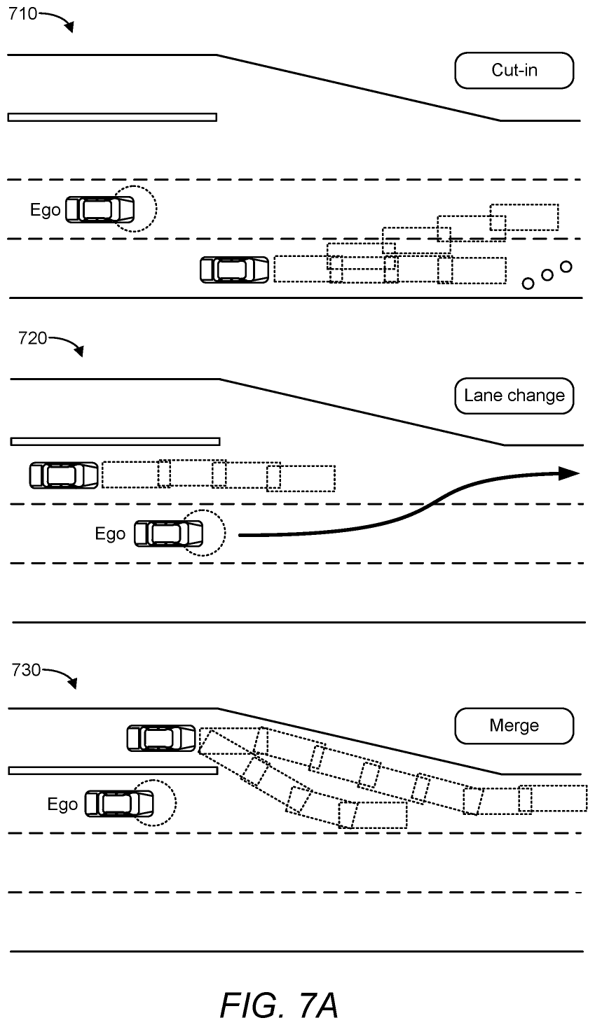

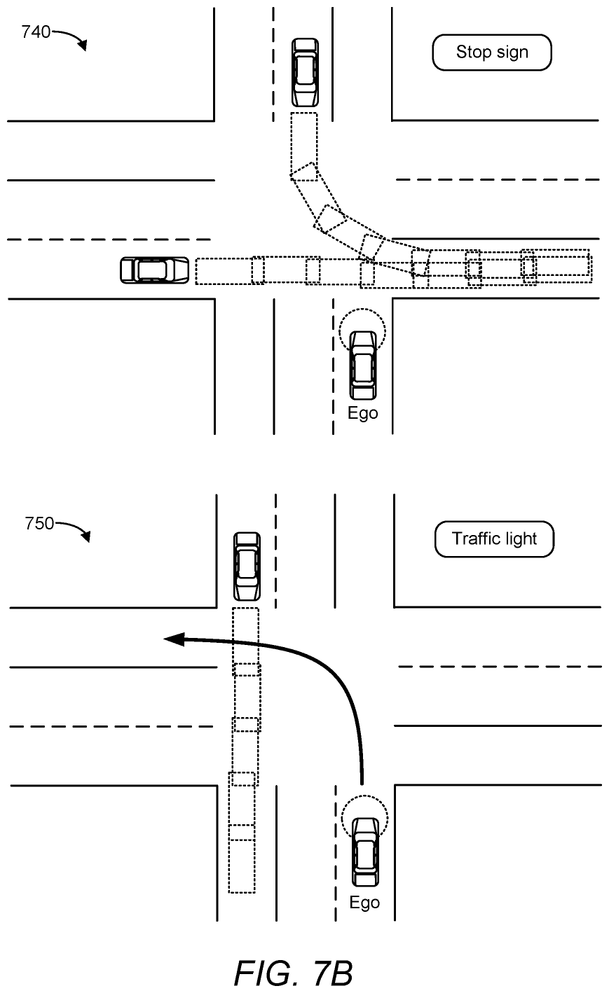

FIGS. 7A and 7B illustrate various scenarios the driving policy engine of an ego vehicle may encounter while performing autonomous or semi-autonomous driving maneuvers, according to aspects of the disclosure. Specifically, diagram 710 illustrates an example cut-in scenario, where a vehicle ahead of the ego vehicle switches into the same lane as the ego vehicle. Diagram 720 illustrates an example lane change scenario, where the go vehicle switches to a different lane (in front of another vehicle). Diagram 730 illustrates an example merge scenario, where another vehicle is merging from around a barrier into the same lane as the ego vehicle. Diagram 740 illustrates an example stop sign scenario, where the ego vehicle has pulled up to a four-way intersection with two other vehicles. Diagram 750 illustrates an example traffic light scenario, where the ego vehicle intends to make a left turn through the intersection.

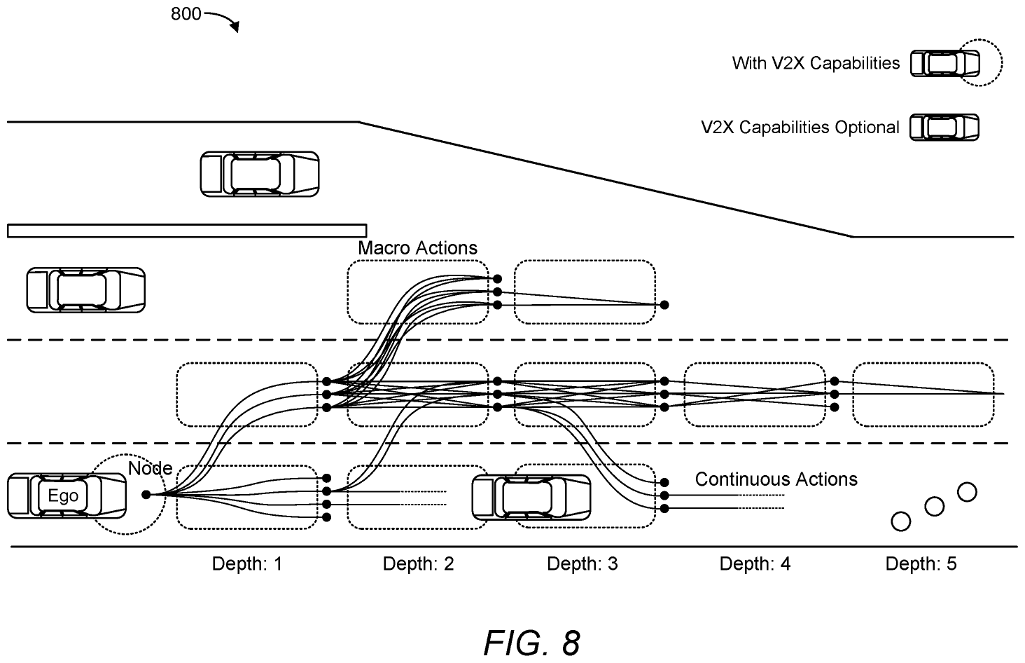

FIG. 8 is a diagram 800 illustrating trajectory generation in an example driving scenario, according to aspects of the disclosure. As shown in FIG. 8, at each depth in front of the ego vehicle (e.g., corresponding to some time or distance in the future), there is a set of one or more macro actions each corresponding to a portion/section/length of a road lane in which the ego vehicle could be located at that depth. Associated with each macro action is a set of one or more nodes (illustrated at the far side of a macro action from the ego vehicle) indicating where within the macro action (the lane) the ego vehicle could be located. Connecting each node is a path/trajectory through the macro action to another macro action. As can be seen, the possibilities quickly expand.

A Monte Carlo Tree Search (MCTS) can be used to focus the search compute on the most promising sub-trees (of possible trajectories), specifically, those minimizing risk and maximizing comfort, progress, etc. In addition, macro action grouping can improve efficiency by focusing on the most rewarding behaviors (e.g., change lanes left, stay in the current lane, etc.). A cost function can be learned from data using supervised learning or inverse reinforcement learning (IRL), and can be extended to risk-averse behavior planning under uncertainty. The Monte Carlo Tree Search is also amenable to parallel acceleration for multiple roots, sub-trees, and leaves.

Note that the Monte Carlo Tree Search may not build a full tree, as shown in FIG. 8. A full tree would be O(b\hat{ }d), where b is the branching factor and d is the depth. The Monte Carlo Tree Search instead has a fixed computational budget (like node count) and allocates the expansion of these nodes to the more promising areas through an explore versus exploit strategy. The Monte Carlo Tree Search is also an “anytime” planning algorithm, in that at any point it can yield the most promising sequence of actions that it has discovered so far, but continue refining the solution as budget allows.

Lateral branching is more computationally expensive than longitudinal-only branching (acceleration actions for the ego vehicle), as the driving policy engine must generally consider more surrounding vehicles. This is mostly due to the requirements to collision-check against a wider swath of space. For example, currently, longitudinal-only branching may be performed at about 5 hertz (Hz) and 10-15 thousand nodes in the tree, while lane changes and lateral offsets may be performed at about 2 Hz with far fewer nodes (e.g., around 100).

In some cases, sensing and perception data (e.g., from camera(s) 312, radar(s) 314, lidar sensor 316, sensor(s) 322) may not be available to the driving policy engine, or may provide a shorter range of sensing than the range of V2X communication. For example, heavy fog may obscure any image data captured by the camera(s) 412, or an obstruction may block the view of a camera 412, a radar 414, or a lidar sensor 416, such that the ego vehicle may not be able to sense more than one or two vehicles around it, if any, using perception sensors. In such cases, V2X communication may be the only available perception input, or at least, may provide information about vehicles further away from the ego vehicle than the ego vehicle's perception sensors can detect. Accordingly, the present disclosure provides techniques for leveraging different types of V2X messages to augment, and even replace if necessary, sensing and perception data. More specifically, the information conveyed by the V2X messages can be used to prune (e.g., remove or de-weight) possible route trajectories.

As a first use case, the V2X messages may be basic safety messages (BSMs). BSMs contain the location and kinematic state of the sender, but do not provide the maneuver intent of the transmitting vehicle. That is, BSMs contain the instantaneous position, speed, and heading of the ego vehicle, but do not indicate whether the ego vehicle is intending to make a turn, lane change, merge, etc.

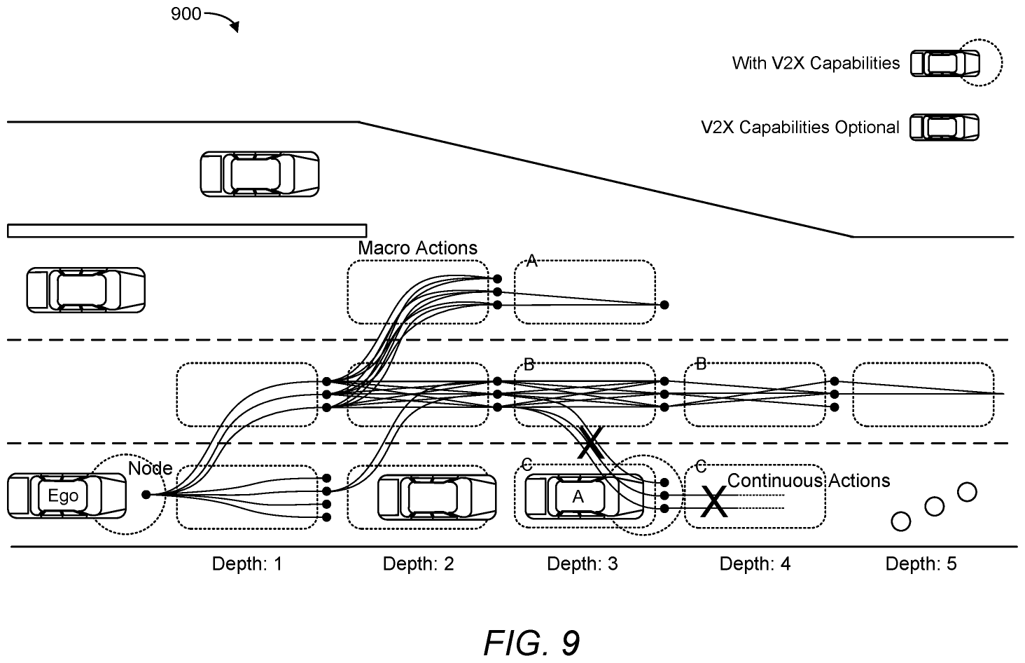

FIG. 9 is a diagram 900 illustrating an example driving scenario in which BSMs can be used to prune possible route trajectories, according to aspects of the disclosure. As shown in FIG. 9, the ego vehicle is computing trajectories (e.g., overtake trajectories) around the vehicle at Depth 2. However, in the example of FIG. 9, the ego vehicle cannot see a second V2X-capable vehicle (denoted “A”) in the same lane and ahead of the vehicle at Depth 3. As such, Depth 3-C (the location of vehicle A) is considered as a viable option by the ego vehicle's drive policy. Potential consequences of this problem include a waste of computational resources, insofar as the drive policy computes trajectories that are not viable. In addition, this problem increases the stress on the computing system, insofar as the drive policy needs to compute new trajectories when it is later discovered/determined that Depth 3-C is not a viable option (e.g., when the ego vehicle reaches Depth 2).

Note that a “viable” trajectory is one that can be driven/followed by the ego vehicle without colliding into another vehicle or obstacle. A viable trajectory is viable at the time it is calculated, but as will be appreciated, the viability of the trajectory may change at some later point. For example, another vehicle may cut in front of the ego vehicle as it follows a chosen viable trajectory, forcing the ego vehicle to update the current trajectory or find a new trajectory.

This additional trajectory computation may be especially burdensome/inefficient because of the type(s) of algorithm(s) being used to calculate the trajectories. For example, for the Monte Carlo Tree Search, this algorithm will balance “explore” versus “exploit” to find good/acceptable trajectory solutions. If vehicle A cannot be seen, then the system will have an incorrect knowledge of the world and may “exploit” the vicinity of vehicle A (i.e., Depth 3-C) because it believes this area to be free. Thus, un-modeled agents (or perhaps more formally, inaccurate distributions) can cause failures in the search by actually focusing on and/or exploiting the very spots that should be avoided.

V2X messaging can be used to solve this problem by providing knowledge of vehicle A. Specifically, because vehicle A is V2X-capable, vehicle A broadcasts BSMs to other nearby V2X-capable vehicles, including the Ego vehicle. Because a BSM includes the location of the transmitting vehicle, the ego vehicle can now “see” that vehicle A is located at Depth 3-C.

The BSM(s) from vehicle A (and any other vehicles not otherwise visible to the ego vehicle) can help the ego vehicle's drive policy trim the tree of trajectories by pruning trajectories and/or nodes (pruning a node prunes the trajectory through that node) that are not viable (e.g., Depth 3-C). Thus, in the example of FIG. 9, the BSM(s) from vehicle A help to remove/prune/de-weight Depth 3-C and Depth 4-C from the possible trajectories/nodes. The use of BSMs to prune trajectories/nodes helps the drive policy achieve higher performance. For example, the drive policy can refocus trajectory and/or node allocation to Depths 3-A and 3-B, which are the true promising areas to search.

As an example, for the Monte Carlo Tree Search, the complexity of building a full tree (or subtree) would be O(b\hat{ }d), where b is the branching factor and d is the depth. However, the Monte Carlo Tree Search algorithm does not build a full tree. Instead, it has a fixed computational budget (e.g., some number of nodes) and uses an “explore” versus “exploit” strategy that is updated online to determine where to spend this budget. Thus, while pruning (e.g., removing, de-weighting, down-weighting) the subtree for Depth 3-C does not necessarily save overall compute time, it does correctly refocus the remaining node budget toward the true promising subtrees. For example, if before reception of the BSM from vehicle A, the subtree for Depth 3-C yielded a high reward but also had several successive paths to explore, it would be possible to exhaust the remaining node budget in the search of only the Depth 3-C subtree. However, after pruning the subtree for Depth 3-C, this node budget would instead be allocated elsewhere. There are two ways to think about this effect. First, fewer nodes may be needed to find the “optimal” trajectory within the search tree that would otherwise include the subtree for Depth 3-C. For example, build the tree with 5000 nodes, remove/prune/de-weight the Depth 3-C subtree that includes 1000 nodes, and find the best trajectory among the remaining 4000 nodes, thus only 4000 nodes are needed to find equivalence. Second, using the same node budget, a more optimal path is more likely to be found. For example, with the same 5000 node budget, by pruning the invalid subtree(s) (e.g., the subtree at Depth 3-C), the solution is optimality increased by X %.

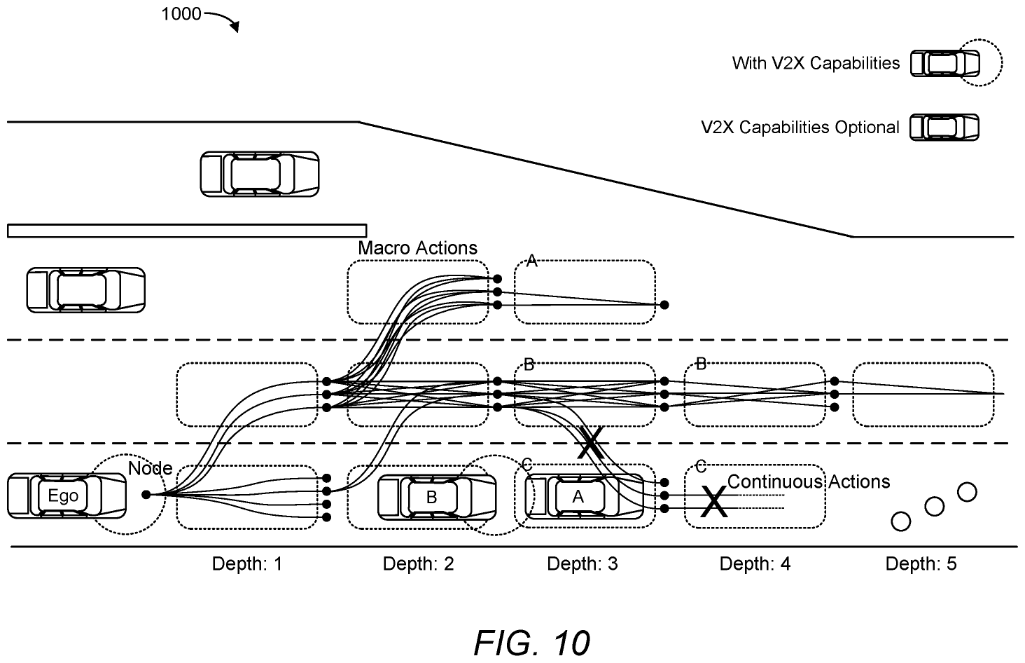

As a second use case, the V2X messages may be collective perception messages (CPMs). FIG. 10 is a diagram 1000 illustrating an example driving scenario in which CPMs can be used to prune possible route trajectories, according to aspects of the disclosure. As shown in FIG. 10, the ego vehicle is computing trajectories (e.g., overtake trajectories) around another V2X-capable vehicle (denoted “B”) in the same lane at Depth 2. However, in the example of FIG. 10, the ego vehicle cannot see a non-V2X-capable vehicle (denoted “A”) in the same lane and ahead of vehicle B. As such, Depth 3-C (the location of vehicle A) is considered as a viable option by the ego vehicle's drive policy.

CPMs provide information about the presence and state of any object(s) perceived by the transmitting vehicle, which is particularly useful where the detected object cannot transmit its own information. For example, CPMs may convey the location/position, speed, heading, and/or type of the detected object (depending on what information can be ascertained by the detecting vehicle). Thus, in the example of FIG. 10, vehicle B broadcasts one or more CPMs indicating that vehicle A is present at Depth 3-C. By receiving and decoding the CPMs from vehicle B, the ego vehicle can now “see” that vehicle A is located at Depth 3-C.

As in the case of using BSMs, the ego vehicle's drive policy can trim the search tree of possible trajectories by pruning trajectories and/or nodes that are not viable (e.g., Depth 3-C). Thus, in the example of FIG. 10, the CPM(s) from vehicle B help to remove/prune/de-weight Depth 3-C and Depth 4-C from the search tree of possible trajectories/nodes. The use of CPMs to prune trajectories/nodes helps the drive policy achieve higher performance. For example, the drive policy can refocus trajectory and/or node allocation to Depths 3-A and 3-B, which are the true promising areas to search.

Even if the CPM(s) from vehicle B do not explicitly or accurately model all the information about vehicle A, there is still benefit to the drive policy. For example, if the CPM(s) simply provide information to the effect of “the road ahead looks like dense traffic,” this information can be probabilistically incorporated into the tree search algorithm (e.g., the Monte Carlo Tree Search algorithm). For example, some model of uncertainty may be added to the reward backpropagation, such that subtrees from Depth 3-C (even without explicit knowledge of vehicle A) still receive less of a reward due to the presence of this unknown/uncertain condition. This would also focus more compute resources to Depths 3-A and 3-B due to the uncertainty present at Depth 3-C.

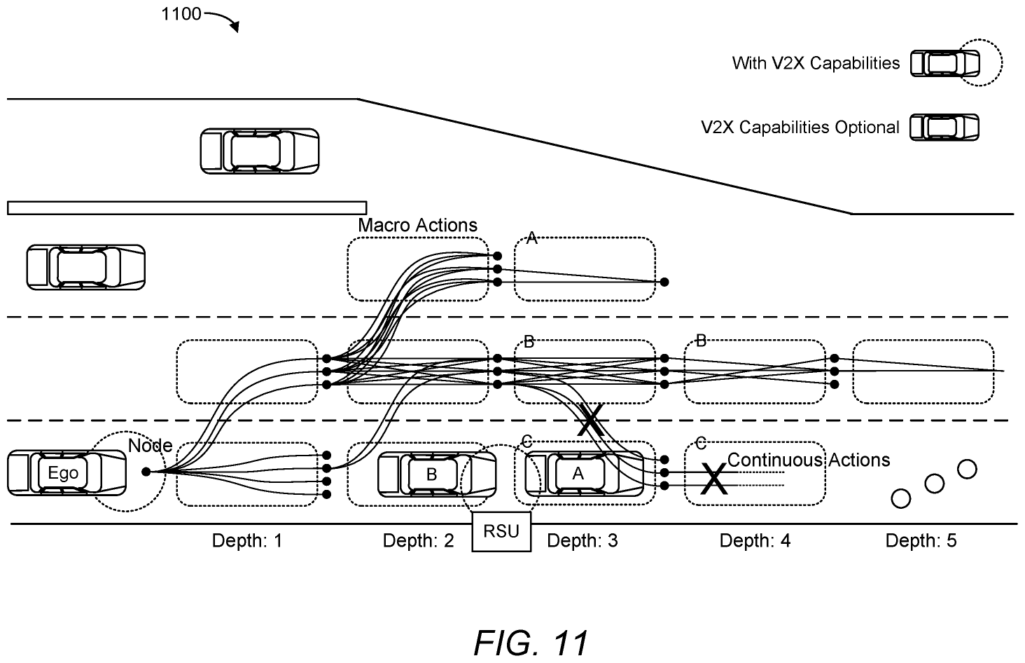

FIG. 11 is a diagram 1100 illustrating another example driving scenario in which CPMs can be used to prune possible route trajectories, according to aspects of the disclosure. As shown in FIG. 11, the ego vehicle is computing trajectories around another vehicle (denoted “B”) in the same lane at Depth 2. However, in the example of FIG. 11, the ego vehicle cannot see a third vehicle (denoted “A”) in the same lane and ahead of vehicle B. As such, Depth 3-C (the location of vehicle A) is considered as a viable option by the ego vehicle's drive policy.

In the example of FIG. 11, neither vehicle A nor vehicle B are V2X-capable vehicles. However, there is a sensor-equipped RSU with V2X capabilities positioned along the highway. In this case, the RSU broadcasts CPMs that are received and decoded by the ego vehicle. While the ego vehicle can likely detect the presence of vehicle B with its own sensors, it can now “see” vehicle A based on the CPM(s) received from the RSU.

As in the above examples, the ego vehicle's drive policy can trim the search tree of possible trajectories by pruning trajectories and/or nodes that are not viable (e.g., Depth 3-C). Thus, in the example of FIG. 11, the CPM(s) from the RSU help to remove/prune/de-weight Depth 3-C and Depth 4-C from the search tree of possible trajectories/nodes. The use of CPMs to prune trajectories/nodes helps the drive policy achieve higher performance. For example, the drive policy can refocus trajectory and/or node allocation to Depths 3-A and 3-B, which are the true promising areas to search.

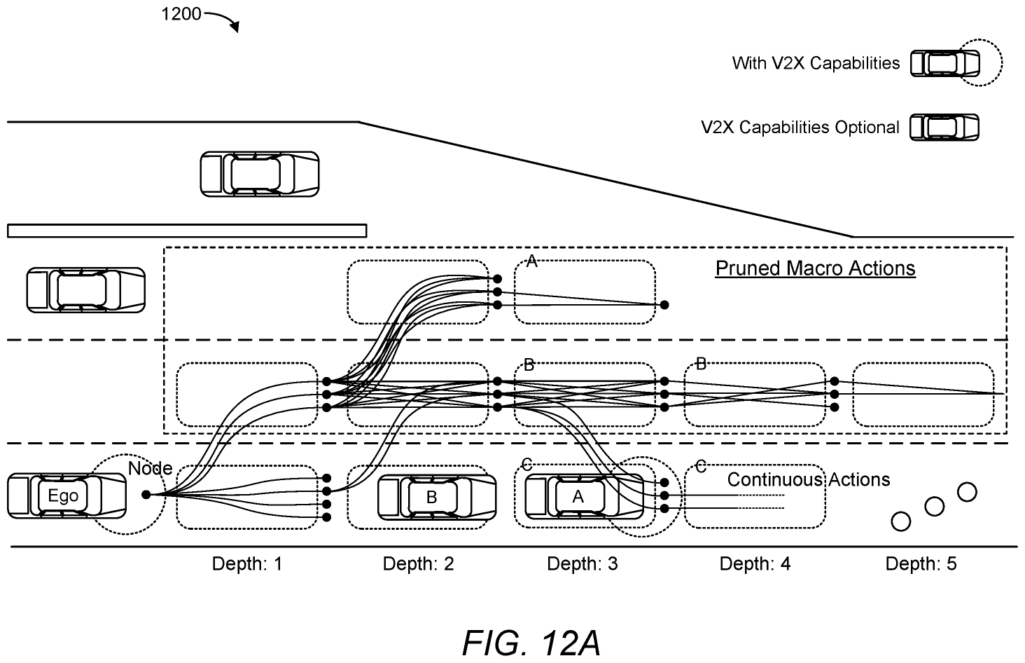

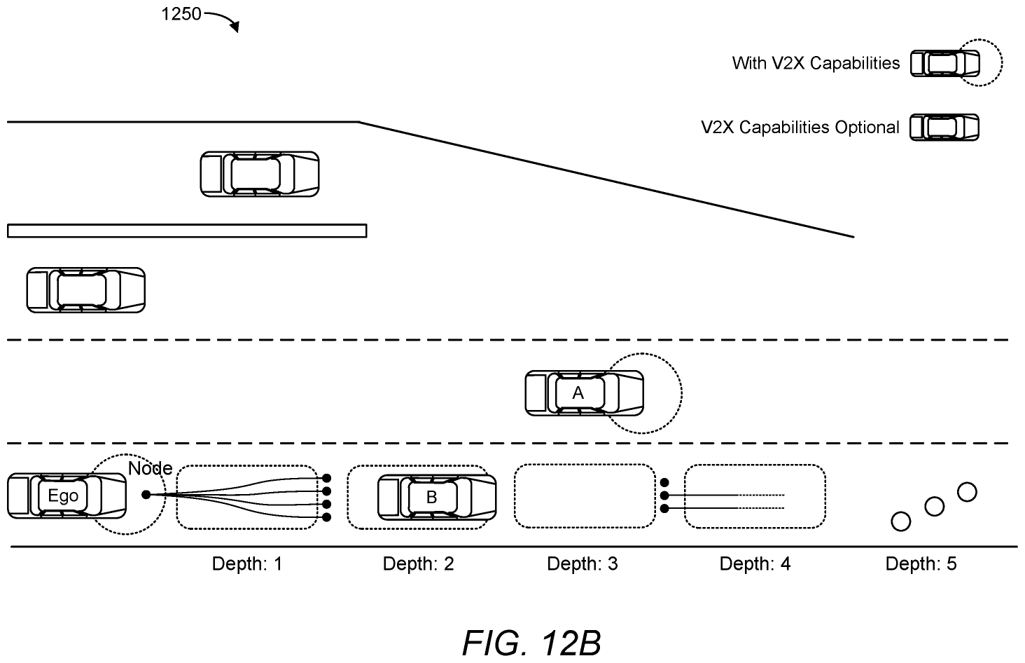

As a third use case, the V2X messages may be maneuver sharing and coordination messages (MSCMs). FIGS. 12A and 12B illustrate an example driving scenario in which MSCMs can be used to prune possible route trajectories, according to aspects of the disclosure. As shown by diagram 1200, the ego vehicle is computing trajectories (e.g., overtake trajectories) around another vehicle (denoted “B”) in the same lane at Depth 2. However, in the example of FIG. 12A, the ego vehicle cannot see (e.g., with its onboard sensors, such as radar-camera sensor module 320) another V2X-capable vehicle (denoted “A”) in the same lane and ahead of vehicle B. As such, Depth 3-C (the location of vehicle A) is considered as a viable option by the ego vehicle's drive policy. In addition, vehicle A intends to perform a maneuver (e.g., a lane change) to get out of the way of vehicle B.

MSCMs are used to share and coordinate intended driving maneuvers (e.g., maneuvers within the next couple of seconds to minutes). Unlike local planning, MSCMs can be used to optimize the planned trajectories by considering the planned trajectories of other vehicles. The protocol uses a request and response design. The requester (e.g., vehicle A in the example of FIG. 12) will send one or more MSCMs to the other maneuver participants (e.g., the ego vehicle in the example of FIG. 12) detailing the maneuver(s) to be performed by the requester and optionally the other participants (if the other participants need to perform any maneuvers associated with the planned maneuver of the requester). Each participant will send a response (another MSCM) to the requester indicating whether the responder agrees or disagrees with the planned maneuver(s). A single negative response ends the maneuver negotiation (protocol session). A unanimous positive answer leads to the start of the maneuver. During the maneuver, participants may send an MSCM to cancel the ongoing maneuver (e.g., due to a flat tire). A maneuver is considered complete as soon as each participant acknowledges (via an MSCM) the completion of its assigned maneuver. Note that for special vehicles (e.g., police, emergency responders), there is no maneuver negotiation.

MSCM maneuver requests may be transmitted via unicast, groupcast, or broadcast mode. In unicast mode, the requester will negotiate the maneuver with a single vehicle. In groupcast mode, the requester can adjust the signal strength and orientate the signal beam to negotiate a maneuver with a subset of surrounding vehicles. Finally, in broadcast mode, the requester negotiates a maneuver with all the vehicles within communication range.

With continued reference to FIGS. 12A and 12B, vehicle A can send an MSCM request to share its intention to switch lanes with the ego vehicle. The ego vehicle now has a drive policy that matches vehicle A's plan. Thus, as shown by diagram 1250, the use of MSCMs can significantly trim the tree of trajectories. The maneuver intention indicated by the MSCM request from vehicle A gives the ego vehicle an idea of the whole future trajectory of vehicle A. This reduces the amount of uncertainty assigned to vehicle A as it is simulated through the depths of the search algorithm/tree, and the ego vehicle can be more confident about the plans it generates as a result.

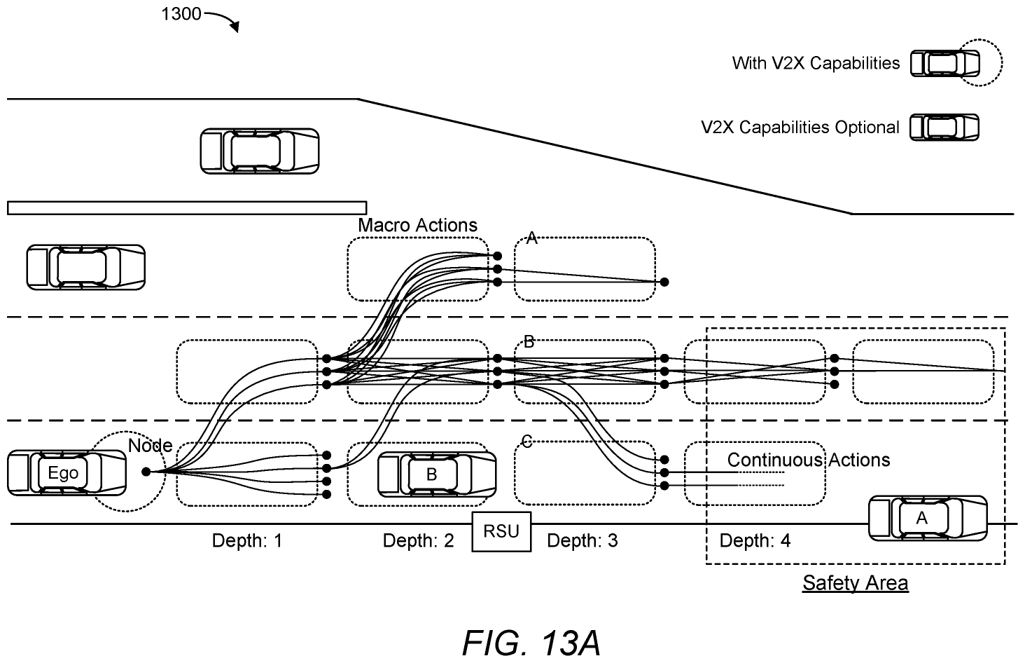

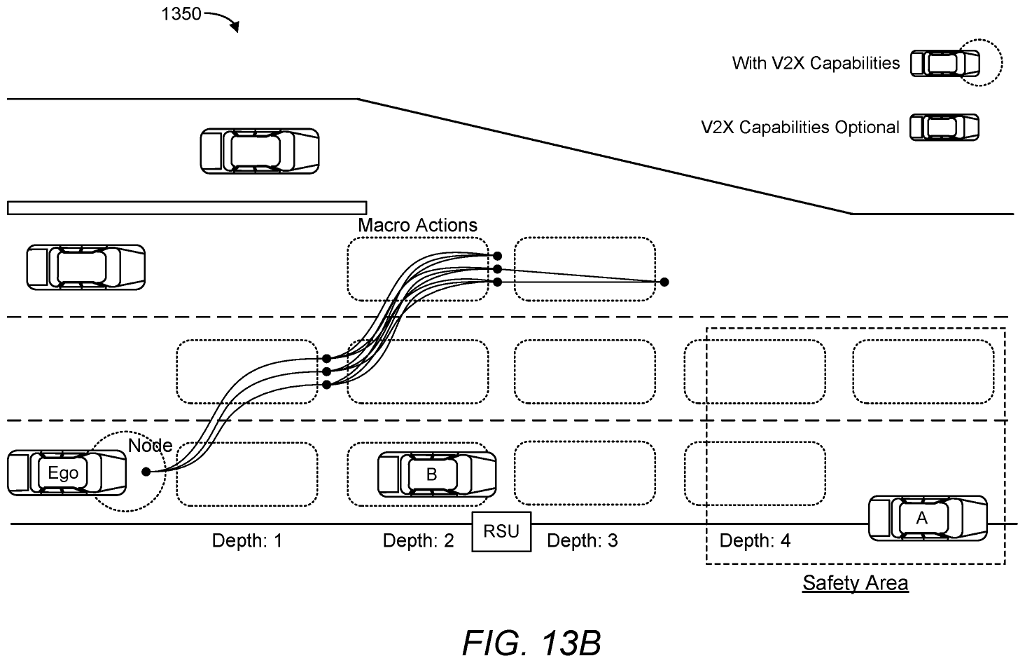

As a fourth use case, the V2X messages may be decentralized environmental notification messages (DENMs). FIGS. 13A and 13B illustrate an example driving scenario in which DENMs can be used to prune possible route trajectories, according to aspects of the disclosure. As shown by diagram 1300, the ego vehicle is computing trajectories (e.g., overtake trajectories) around another vehicle (denoted “B”) in the same lane at Depth 2. However, in the example of FIG. 13A, the ego vehicle is not aware of a safety area ahead of the vehicle B due to a vehicle (denoted “A”) stopped along the side of the road.

In the example of FIGS. 13A and 13B, a sensor-equipped RSU with V2X capabilities is aware of the safety area caused by vehicle A. In this case, the RSU can transmit one or more DENMs indicating that vehicle A is stationary and that there is a safety area around the event. DENMs are mainly used by the Cooperative Road Hazard Warning (RHW) application in order to alert road users of detected events. Upon detection of an event that corresponds to an RHW use case, the RSU immediately broadcasts a DENM to other RSUs and/or V2X-capable vehicles located inside a geographical area that are concerned by the event. This DENM broadcasting persists as long as the event is present. The termination of the DENM broadcasting is either automatic once the event disappears (after a predefined expiry time), or by an RSU that generates a special DENM to inform that the event has disappeared. DENMs may be used to alert regarding hard breaking of a vehicle, wrong way driving, stationary vehicle (due to accident or vehicle problem), traffic condition warning, signal violation warning, road work warning, collision risk warning, hazardous location, precipitation, slippery road, low visibility, or strong winds.

As shown in diagram 1350, based on the received DENM(s), the ego vehicle can update its drive policy to avoid the safety area (e.g., prune subtrees that conflict with the safety area). As in the previous examples, this can significantly trim the trajectories represented by the search tree, thereby improving the performance of the drive policy.

With continued reference to the example scenario illustrated in FIGS. 13A and 13B, the RSU could transmit more than just an indication of the safety area. Instead, the RSU may provide information to give an ego vehicle a full understanding of how the world might evolve within the area that the RSU can observe. In this case, the RSU may “plan” trajectories with the same algorithm(s) as the ego vehicle. The RSU may create a subtree that could be inserted or augmented very efficiently together with the ego vehicle's search tree.

In greater detail, while the RSU has knowledge about the stationary vehicle, it could create one or more route plans (e.g., via Monte Carlo Tree Search) that it knows can safely navigate the space. The RSU can then transmit these plans to V2X-capable vehicles that approach the scene (e.g., the ego vehicle in FIGS. 13A and 13B). The receiving ego vehicle can then either (1) accept a plan as the trajectory it will execute, or (2) add the plan to its own search tree as a heavy prior. This “prior” could be in the form of “guidance” (heavily biasing the actions that branch at each node to prefer actions that follow closely to the RSU-provided plan(s)) or through rewards (heavily reward trajectories that are similar to the RSU-provided plan(s)).

This concept can be extended beyond RSUs. For example, other V2X-capable autonomous or semi-autonomous vehicles can pass along safe trajectories that they have just calculated to the V2X-capable vehicle(s) behind them. In that way, every new vehicle through a given space builds upon some amount of computation that was just performed by its predecessors. In some cases, the RSU may act as a relay and bundle up some promising actions that all nearby vehicles have found and then serve them to others.

In some cases, a V2X-capable vehicle may transmit several types of V2X messages, such as one or more BSMs, CPMs, and/or MSCMs. An ego vehicle can then apply its drive policy to the information received from the other V2X-capable vehicle(s). The goal is to anticipate several Depths into the future trajectory of other V2X-capable vehicles, and thereby improve the ego vehicle's trajectory/route planning.

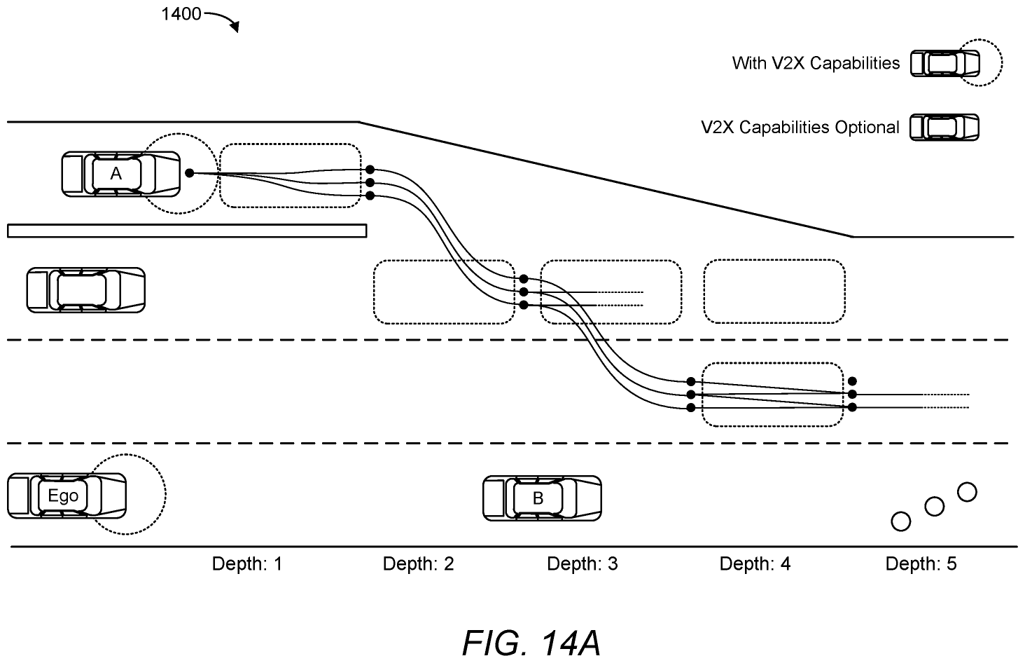

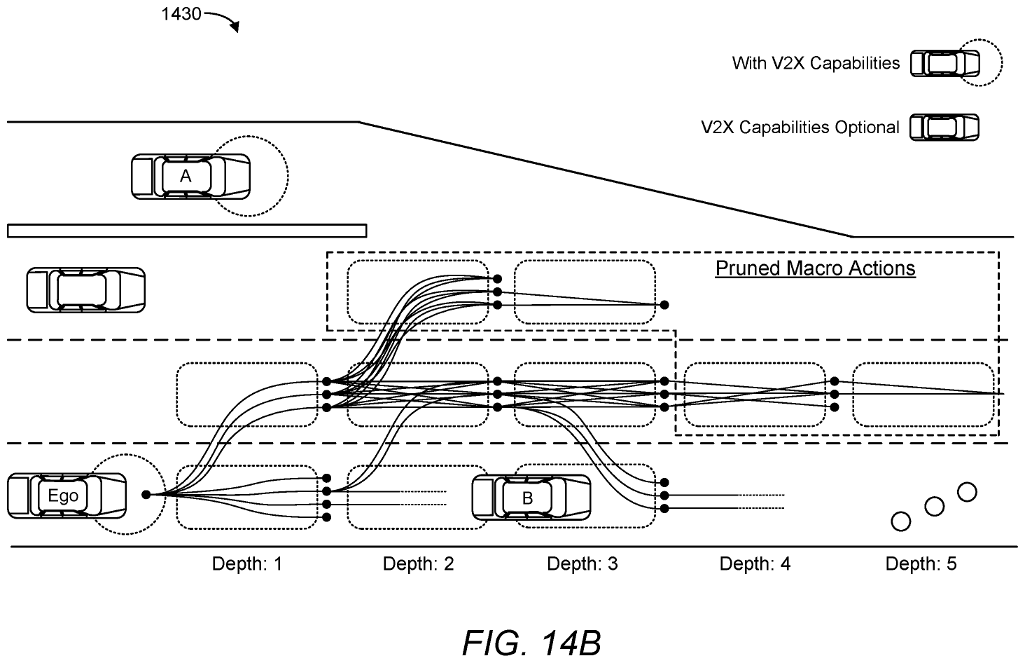

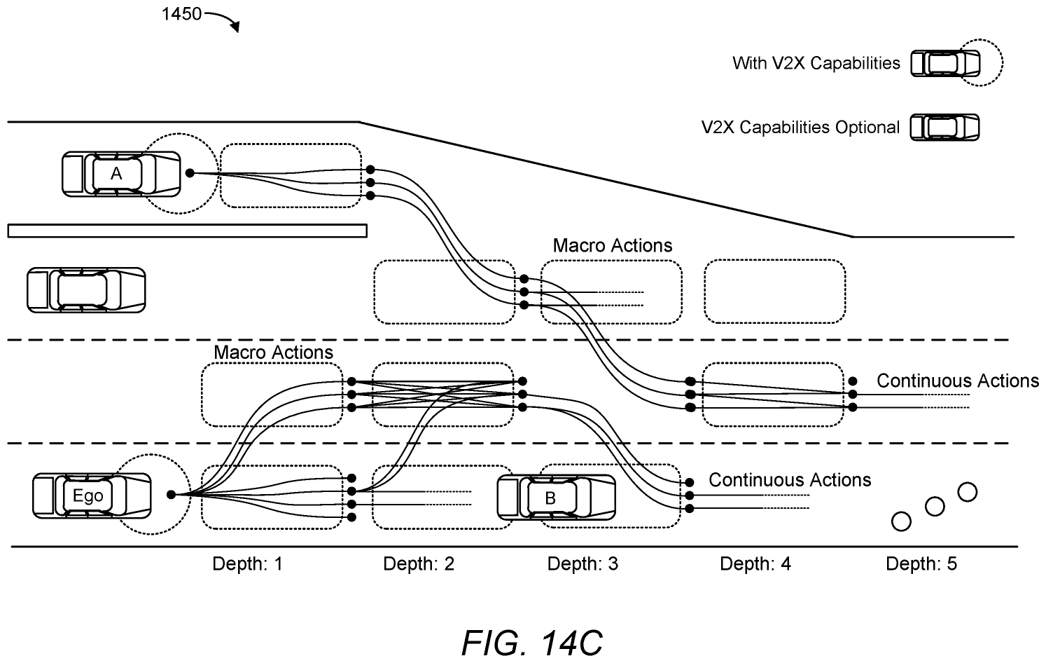

FIGS. 14A to 14C illustrate an example driving scenario in which various V2X messages can be used to prune possible route trajectories, according to aspects of the disclosure. As shown in diagram 1400, a V2X-capable vehicle (denoted “A”) has computed and is now sharing intended trajectories for merging onto a highway on which the ego vehicle is driving. The intended trajectories may be transmitted (via unicast, groupcast, or broadcast) in one or more MSCMs, for example. However, in the example of FIG. 14A, the ego vehicle cannot see (e.g., with its onboard sensors, such as radar-camera sensor module 320) vehicle A because, for example, it is behind a barrier dividing the merge lane from the highway.

As shown in diagram 1430, the ego vehicle is computing trajectories (e.g., overtake trajectories) around another vehicle (denoted “B”) in the same lane. Using the intended trajectories received from vehicle A, the ego vehicle can prune certain macro actions from the tree of trajectories. Specifically, as shown in FIG. 14B, the ego vehicle's drive policy can prune macro actions overlapping the macro actions indicated by vehicle A, macro actions connected to pruned macro actions, and nodes connected to pruned macro actions.

In this way, the drive policy for the ego vehicle adapts based on the drive policy of other V2X vehicles (e.g., vehicle A in FIGS. 14A-14C).

Diagram 1450 shows the resulting search tree for the ego vehicle. As will be appreciated, this technique helps the drive policy engine to be more compute efficient to find the best trajectory by, for example, storing fewer impossible actions and improving its time efficient policy (e.g., this lane is occupied for X seconds, so no associated prediction is needed). This technique thereby introduces a cooperative drive policy (i.e., between the ego vehicle and other V2X-capable vehicles, such as vehicle A in FIGS. 14A-14C).

The technique described with reference to FIGS. 14A-14C may be particularly beneficial for low-trim V2X-capable vehicles. Specifically, since these vehicles may have fewer, if any, sensors (e.g., radar-camera sensor module(s) 320), the V2X sensing techniques described above can fill the gaps in both the perceptual sensing capabilities and any gaps in route planning capabilities. Low-trim vehicles may also or alternatively not have the compute bandwidth for a high-fidelity tree search, but every individual vehicle capable of broadcasting their intentions/desires and assembling the surrounding pieces can effectively reconstruct a high-fidelity decision-making block.

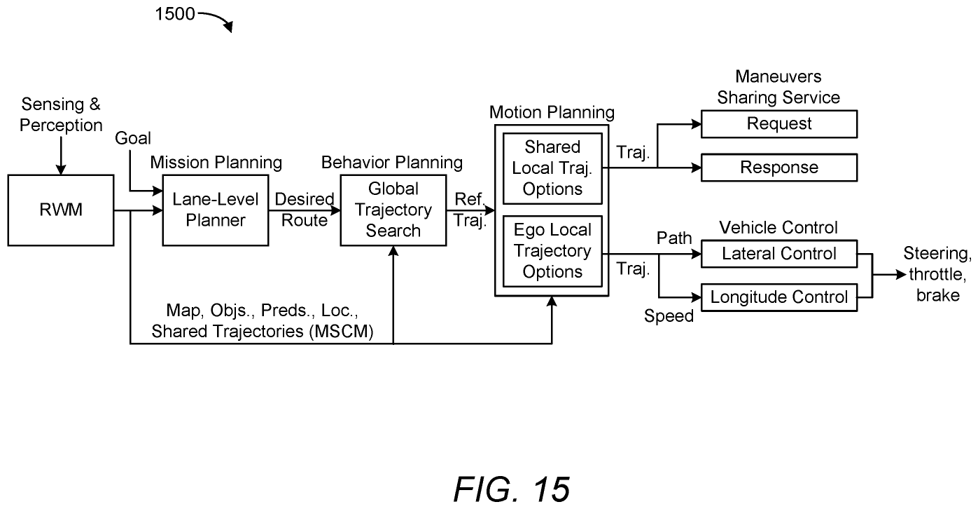

FIG. 15 is a diagram 1500 illustrating an example driving policy pipeline implementing V2X-based trajectory processing, according to aspects of the disclosure. As shown in FIG. 15, at a high level, sensing and perception information (e.g., from camera(s) 312, radar(s) 314, lidar sensor 316, sensor(s) 322) and V2X information (e.g., from one or more V2X messages) is fed into an RWM block. The RWM block outputs map data (e.g., from map(s) 302), object detection results (e.g., of both fixed and moving objects), trajectory predictions of detected moving objects, the location of the vehicle, and any shared trajectories from the V2X messages (e.g., MSCMs) to a lane-level planner block, a global trajectory search block, and a motion planning block.

The lane-level planner block and the global trajectory search block, which were discussed in greater detail above with reference to FIG. 5, may use the available shared trajectories from the V2X messages for route planning, as discussed above with reference to FIGS. 9 to 14C. Unlike the pipeline illustrated in FIG. 5, the motion planning block includes a shared local trajectory optimization block and an ego local trajectory optimization block. The shared local trajectory optimization block determines the optimum trajectory among the shared trajectories, and the ego local trajectory optimization block determines the optimum trajectory for the ego vehicle. The shared local trajectory optimization block communicates with a maneuver sharing service, while the ego local trajectory optimization block may provide control signals to the vehicle control system.

More specifically, the ego vehicle trajectory can be part of the shared local trajectory. For instance, the ego vehicle may intend to overtake another vehicle. To do so, the ego vehicle needs to share the ego vehicle trajectory, which is handled by the shared local trajectory optimization block. Additionally or alternatively, the shared local trajectory can contain an ego vehicle trajectory. For instance, another vehicle may request the ego vehicle to move to a different lane. The shared trajectory will contain the requested trajectory for the ego vehicle. Then, it is up to the shared local trajectory optimization block to decide whether or not the requested ego vehicle trajectory is optimizing or is aggravating the current ego vehicle trajectory.

Note that in some cases, an RSU (e.g., base station/RSU 404) or a network entity (e.g., network entity 406), such as an edge server, may function as a virtual on-board computer for one or more multiple V2X-capable vehicles (e.g., V2X-capable vehicle 300). For example, the RSU/server may receive V2X messages transmitted in the vicinity of a V2X-capable vehicle and may determine viable trajectories as described herein and provide them to the V2X-capable vehicle to reduce the number of processing operations performed by the V2X-capable vehicle.

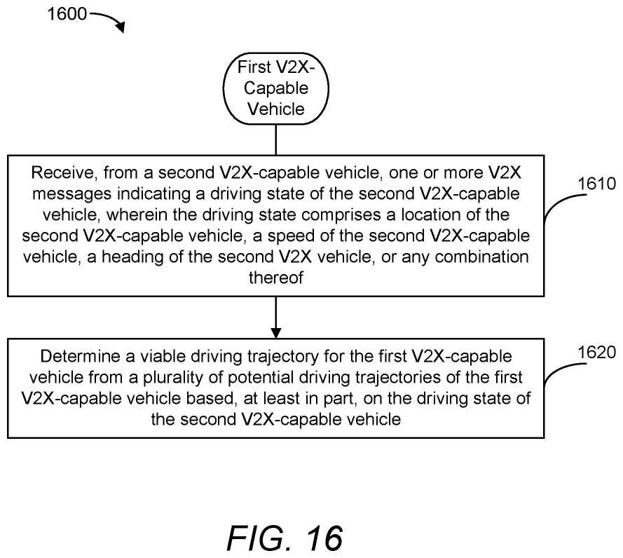

FIG. 16 illustrates an example method 1600 of wireless communication, according to aspects of the disclosure. In an aspect, method 1600 may be performed by a first V2X-capable vehicle (e.g., V2X-capable vehicle 300, OBC 380, or any other V2X-capable vehicle described herein).

At 1610, the first V2X-capable vehicle receives, from a second V2X-capable vehicle, one or more V2X messages (e.g., BSMs) indicating a driving state of the second V2X-capable vehicle, wherein the driving state comprises a location of the second V2X-capable vehicle, a speed of the second V2X-capable vehicle, a heading of the second V2X vehicle, or any combination thereof. In an aspect, operation 1610 may be performed by the one or more WWAN transceivers 330, the one or more short-range wireless transceivers 340, the one or more processors 306, memory 304, and/or drive policy component 318, any or all of which may be considered means for performing this operation.

At 1620, the first V2X-capable vehicle determines a viable driving trajectory for the first V2X-capable vehicle from a plurality of potential driving trajectories of the first V2X-capable vehicle based, at least in part, on the driving state of the second V2X-capable vehicle, as described above at least with reference to FIG. 9. In an aspect, operation 1620 may be performed by the one or more WWAN transceivers 330, the one or more short-range wireless transceivers 340, the one or more processors 306, memory 304, and/or drive policy component 318, any or all of which may be considered means for performing this operation.

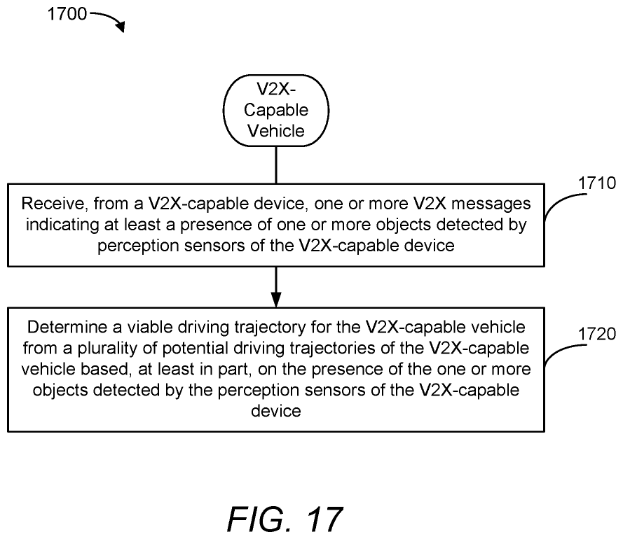

FIG. 17 illustrates an example method 1700 of wireless communication, according to aspects of the disclosure. In an aspect, method 1700 may be performed by a V2X-capable vehicle (e.g., V2X-capable vehicle 300, OBC 380, or any other V2X-capable vehicle described herein).

At 1710, the V2X-capable vehicle receives, from a V2X-capable device, one or more V2X messages (e.g., CPMs) indicating at least a presence of one or more objects detected by perception sensors of the V2X-capable device. In an aspect, operation 1710 may be performed by the one or more WWAN transceivers 330, the one or more short-range wireless transceivers 340, the one or more processors 306, memory 304, and/or drive policy component 318, any or all of which may be considered means for performing this operation.

At 1720, the V2X-capable vehicle determines a viable driving trajectory for the V2X-capable vehicle from a plurality of potential driving trajectories of the V2X-capable vehicle based, at least in part, on the presence of the one or more objects detected by the perception sensors of the V2X-capable device, as described above at least with reference to FIG. 10. In an aspect, operation 1720 may be performed by the one or more WWAN transceivers 330, the one or more short-range wireless transceivers 340, the one or more processors 306, memory 304, and/or drive policy component 318, any or all of which may be considered means for performing this operation.

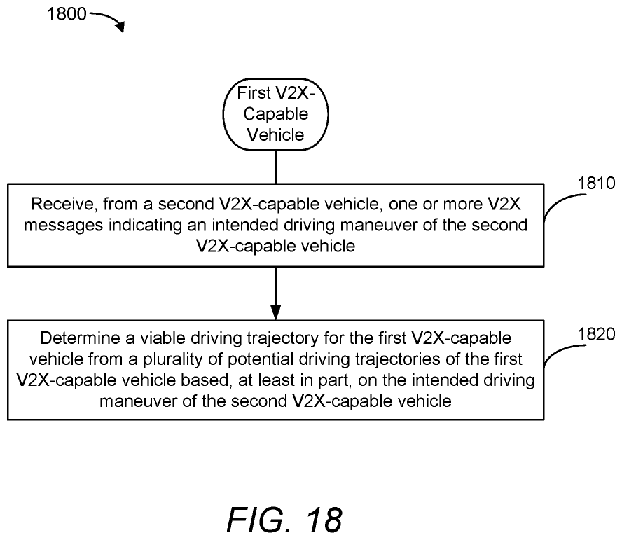

FIG. 18 illustrates an example method 1800 of wireless communication, according to aspects of the disclosure. In an aspect, method 1800 may be performed by a first V2X-capable vehicle (e.g., V2X-capable vehicle 300, OBC 380, or any other V2X-capable vehicle described herein).

At 1810, the first V2X-capable vehicle receives, from a second V2X-capable vehicle, one or more V2X messages (e.g., MSCMs) indicating an intended driving maneuver of the second V2X-capable vehicle. In an aspect, operation 1810 may be performed by the one or more WWAN transceivers 330, the one or more short-range wireless transceivers 340, the one or more processors 306, memory 304, and/or drive policy component 318, any or all of which may be considered means for performing this operation.

At 1820, the first V2X-capable vehicle determines a viable driving trajectory for the V2X-capable vehicle from a plurality of potential driving trajectories of the V2X-capable vehicle based, at least in part, on the presence of the one or more objects detected by the perception sensors of the V2X-capable device, as described above at least with reference to FIGS. 12A-12B. In an aspect, operation 1820 may be performed by the one or more WWAN transceivers 330, the one or more short-range wireless transceivers 340, the one or more processors 306, memory 304, and/or drive policy component 318, any or all of which may be considered means for performing this operation.

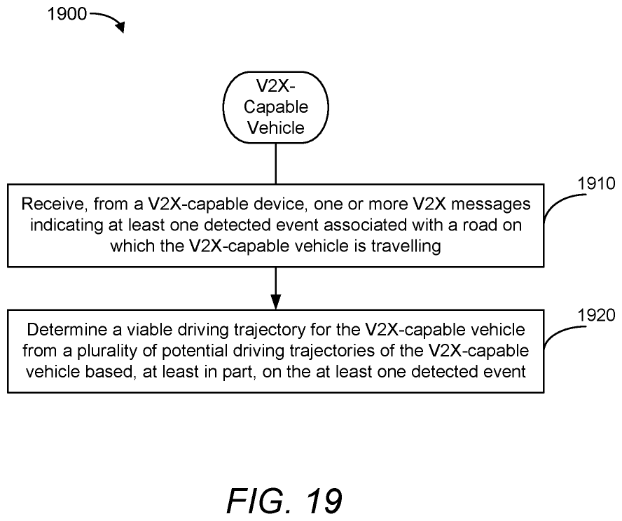

FIG. 19 illustrates an example method 1900 of wireless communication, according to aspects of the disclosure. In an aspect, method 1900 may be performed by a V2X-capable vehicle (e.g., V2X-capable vehicle 300, OBC 380, or any other V2X-capable vehicle described herein).

At 1910, the V2X-capable vehicle receives, from a V2X-capable device, one or more V2X messages (e.g., DENMs) indicating at least one detected event associated with a road on which the V2X-capable vehicle is travelling. In an aspect, operation 1910 may be performed by the one or more WWAN transceivers 330, the one or more short-range wireless transceivers 340, the one or more processors 306, memory 304, and/or drive policy component 318, any or all of which may be considered means for performing this operation.

At 1920, the V2X-capable vehicle determines a viable driving trajectory for the V2X-capable vehicle from a plurality of potential driving trajectories of the V2X-capable vehicle based, at least in part, on the at least one detected event, as described above at least with reference to FIGS. 13A-13B. In an aspect, operation 1920 may be performed by the one or more WWAN transceivers 330, the one or more short-range wireless transceivers 340, the one or more processors 306, memory 304, and/or drive policy component 318, any or all of which may be considered means for performing this operation.

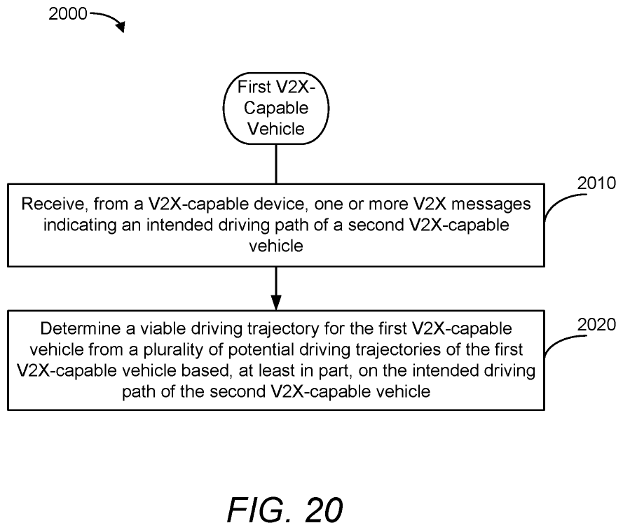

FIG. 20 illustrates an example method 2000 of wireless communication, according to aspects of the disclosure. In an aspect, method 2000 may be performed by a first V2X-capable vehicle (e.g., V2X-capable vehicle 300, OBC 380, or any other V2X-capable vehicle described herein).

At 2010, the first V2X-capable vehicle receives, from a V2X-capable device (e.g., a second V2X-capable vehicle, a third V2X-capable vehicle, or roadside infrastructure), one or more V2X messages (e.g., one or more BSMs, CPMs, MSCMs, DENMs, or any combination thereof) indicating an intended driving path of a second V2X-capable vehicle. In an aspect, operation 2010 may be performed by the one or more WWAN transceivers 330, the one or more short-range wireless transceivers 340, the one or more processors 306, memory 304, and/or drive policy component 318, any or all of which may be considered means for performing this operation.

At 2020, the first V2X-capable vehicle determines a viable driving trajectory for the first V2X-capable vehicle from a plurality of potential driving trajectories of the first V2X-capable vehicle based, at least in part, on the driving state of the second V2X-capable vehicle, as described above at least with reference to FIGS. 14A-14C. In an aspect, operation 2020 may be performed by the one or more WWAN transceivers 330, the one or more short-range wireless transceivers 340, the one or more processors 306, memory 304, and/or drive policy component 318, any or all of which may be considered means for performing this operation.

As will be appreciated, a technical advantage of the methods 1600 to 2000 is improved route planning, particularly in the absence of sensing information from perception sensors of the (first) V2X-capable vehicle (e.g., due to visual blockages, weather, etc.).

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of wireless communication performed by a first vehicle-to-everything (V2X)-capable vehicle, comprising: receiving, from a second V2X-capable vehicle, one or more V2X messages indicating a driving state of the second V2X-capable vehicle, wherein the driving state comprises a location of the second V2X-capable vehicle, a speed of the second V2X-capable vehicle, a heading of the second V2X vehicle, or any combination thereof; and determining a viable driving trajectory for the first V2X-capable vehicle from a plurality of potential driving trajectories of the first V2X-capable vehicle based, at least in part, on the driving state of the second V2X-capable vehicle.

Clause 2. The method of clause 1, wherein determining the viable driving trajectory comprises: determining non-viable driving trajectories of the plurality of potential driving trajectories based, at least in part, on the driving state of the second V2X-capable vehicle; and removing (or pruning or de-weighting) the non-viable driving trajectories from the plurality of potential driving trajectories to determine a set of remaining driving trajectories of the plurality of potential driving trajectories, wherein the viable driving trajectory for the first V2X-capable vehicle is a remaining driving trajectory of the set of remaining driving trajectories.

Clause 3. The method of clause 2, further comprising: transmitting the set of remaining driving trajectories to one or more other V2X-capable vehicles, roadside infrastructure, or any combination thereof.

Clause 4. The method of any of clauses 1 to 3, wherein determining the viable driving trajectory comprises: determining non-viable driving trajectories of the plurality of potential driving trajectories based, at least in part, on the driving state of the second V2X-capable vehicle; and reallocating nodes from the non-viable driving trajectories to remaining driving trajectories of the plurality of potential driving trajectories, wherein the viable driving trajectory for the first V2X-capable vehicle is a remaining driving trajectory of the plurality of potential driving trajectories, wherein each node represents a position on a potential driving trajectory through a macro action of one or more macro actions, and wherein each macro action represents a portion of a lane of a road on which the first V2X-capable vehicle is travelling.

Clause 5. The method of any of clauses 1 to 4, wherein determining the viable driving trajectory comprises: building a search tree of the plurality of potential driving trajectories, wherein each of the plurality of potential driving trajectories corresponds to a subtree of the search tree.

Clause 6. The method of clause 5, wherein: each subtree of the search tree comprises one or more macro actions, each macro action represents a portion of a lane of a road on which the first V2X-capable vehicle is travelling and is associated with one or more nodes, and each node represents a position on a potential driving trajectory through the portion of the lane of the road represented by the corresponding macro action.

Clause 7. The method of any of clauses 5 to 6, wherein determining the viable driving trajectory comprises: determining subtrees of the search tree corresponding to non-viable driving trajectories of the plurality of potential driving trajectories based, at least in part, on the driving state of the second V2X-capable vehicle; and removing (or pruning or de-weighting) the subtrees of the search tree corresponding to the non-viable driving trajectories from the plurality of potential driving trajectories, wherein the viable driving trajectory for the first V2X-capable vehicle corresponds to a remaining subtree of the search tree.

Clause 8. The method of clause 7, further comprising: transmitting remaining subtrees of the search tree to one or more other V2X-capable vehicles, roadside infrastructure, or any combination thereof.

Clause 9. The method of any of clauses 5 to 8, wherein determining the viable driving trajectory comprises: determining subtrees of the search tree corresponding to non-viable driving trajectories of the plurality of potential driving trajectories based, at least in part, on the driving state of the second V2X-capable vehicle; and reallocating nodes from the subtrees of the search tree corresponding to the non-viable driving trajectories to remaining subtrees of the search tree, wherein the viable driving trajectory for the first V2X-capable vehicle corresponds to a remaining subtree of the search tree, wherein each node represents a position on a potential driving trajectory through a macro action of one or more macro actions, and wherein each macro action represents a portion of a lane of a road on which the first V2X-capable vehicle is travelling.

Clause 10. The method of any of clauses 5 to 9, wherein the search tree comprises a Monte Carlo Tree Search.

Clause 11. The method of any of clauses 1 to 10, further comprising: transmitting the viable driving trajectory to one or more other V2X-capable vehicles, roadside infrastructure, or any combination thereof; receiving one or more driving trajectories from the one or more other V2X-capable vehicles, the roadside infrastructure, or any combination thereof, wherein the viable driving trajectory is determined further based on the one or more driving trajectories; or any combination thereof.

Clause 12. The method of any of clauses 1 to 11, wherein the second V2X-capable vehicle is blocked from view of perception sensors of the first V2X-capable vehicle.

Clause 13. The method of clause 12, wherein the perception sensors of the first V2X-capable vehicle comprise: one or more radar sensors, a lidar sensor, one or more cameras, or any combination thereof.

Clause 14. The method of any of clauses 1 to 13, wherein the one or more V2X messages are one or more basic safety messages (BSMs).

Clause 15. The method of any of clauses 1 to 14, further comprising: performing a driving maneuver according to the viable driving trajectory.

Clause 16. A first vehicle-to-everything (V2X)-capable vehicle, comprising: one or more memories; one or more transceivers; and one or more processors communicatively coupled to the one or more memories and the one or more transceivers, the one or more processors, either alone or in combination, configured to: receive, via the one or more transceivers, from a second V2X-capable vehicle, one or more V2X messages indicating a driving state of the second V2X-capable vehicle, wherein the driving state comprises a location of the second V2X-capable vehicle, a speed of the second V2X-capable vehicle, a heading of the second V2X vehicle, or any combination thereof; and determine a viable driving trajectory for the first V2X-capable vehicle from a plurality of potential driving trajectories of the first V2X-capable vehicle based, at least in part, on the driving state of the second V2X-capable vehicle.

Clause 17. The first V2X-capable vehicle of clause 16, wherein the one or more processors configured to determine the viable driving trajectory comprises the one or more processors, either alone or in combination, configured to: determine non-viable driving trajectories of the plurality of potential driving trajectories based, at least in part, on the driving state of the second V2X-capable vehicle; and remove the non-viable driving trajectories from the plurality of potential driving trajectories to determine a set of remaining driving trajectories of the plurality of potential driving trajectories, wherein the viable driving trajectory for the first V2X-capable vehicle is a remaining driving trajectory of the set of remaining driving trajectories.

Clause 18. The first V2X-capable vehicle of clause 17, wherein the one or more processors, either alone or in combination, are further configured to: transmit, via the one or more transceivers, the set of remaining driving trajectories to one or more other V2X-capable vehicles, roadside infrastructure, or any combination thereof.

Clause 19. The first V2X-capable vehicle of any of clauses 16 to 18, wherein the one or more processors configured to determine the viable driving trajectory comprises the one or more processors, either alone or in combination, configured to: determine non-viable driving trajectories of the plurality of potential driving trajectories based, at least in part, on the driving state of the second V2X-capable vehicle; and reallocate nodes from the non-viable driving trajectories to remaining driving trajectories of the plurality of potential driving trajectories, wherein the viable driving trajectory for the first V2X-capable vehicle is a remaining driving trajectory of the plurality of potential driving trajectories, wherein each node represents a position on a potential driving trajectory through a macro action of one or more macro actions, and wherein each macro action represents a portion of a lane of a road on which the first V2X-capable vehicle is travelling.

Clause 20. The first V2X-capable vehicle of any of clauses 16 to 19, wherein the one or more processors configured to determine the viable driving trajectory comprises the one or more processors, either alone or in combination, configured to: build a search tree of the plurality of potential driving trajectories, wherein each of the plurality of potential driving trajectories corresponds to a subtree of the search tree.

Clause 21. The first V2X-capable vehicle of clause 20, wherein: each subtree of the search tree comprises one or more macro actions, each macro action represents a portion of a lane of a road on which the first V2X-capable vehicle is travelling and is associated with one or more nodes, and each node represents a position on a potential driving trajectory through the portion of the lane of the road represented by the corresponding macro action.

Clause 22. The first V2X-capable vehicle of any of clauses 20 to 21, wherein the one or more processors configured to determine the viable driving trajectory comprises the one or more processors, either alone or in combination, configured to: determine subtrees of the search tree corresponding to non-viable driving trajectories of the plurality of potential driving trajectories based, at least in part, on the driving state of the second V2X-capable vehicle; and remove the subtrees of the search tree corresponding to the non-viable driving trajectories from the plurality of potential driving trajectories, wherein the viable driving trajectory for the first V2X-capable vehicle corresponds to a remaining subtree of the search tree.

Clause 23. The first V2X-capable vehicle of clause 22, wherein the one or more processors, either alone or in combination, are further configured to: transmit, via the one or more transceivers, remaining subtrees of the search tree to one or more other V2X-capable vehicles, roadside infrastructure, or any combination thereof.

Clause 24. The first V2X-capable vehicle of any of clauses 20 to 23, wherein the one or more processors configured to determine the viable driving trajectory comprises the one or more processors, either alone or in combination, configured to: determine subtrees of the search tree corresponding to non-viable driving trajectories of the plurality of potential driving trajectories based, at least in part, on the driving state of the second V2X-capable vehicle; and reallocate nodes from the subtrees of the search tree corresponding to the non-viable driving trajectories to remaining subtrees of the search tree, wherein the viable driving trajectory for the first V2X-capable vehicle corresponds to a remaining subtree of the search tree, wherein each node represents a position on a potential driving trajectory through a macro action of one or more macro actions, and wherein each macro action represents a portion of a lane of a road on which the first V2X-capable vehicle is travelling.

Clause 25. The first V2X-capable vehicle of any of clauses 20 to 24, wherein the search tree comprises a Monte Carlo Tree Search.

Clause 26. The first V2X-capable vehicle of any of clauses 16 to 25, wherein the one or more processors, either alone or in combination, are further configured to: transmit, via the one or more transceivers, the viable driving trajectory to one or more other V2X-capable vehicles, roadside infrastructure, or any combination thereof; receive, via the one or more transceivers, one or more driving trajectories from the one or more other V2X-capable vehicles, the roadside infrastructure, or any combination thereof, wherein the viable driving trajectory is determined further based on the one or more driving trajectories; or any combination thereof.

Clause 27. The first V2X-capable vehicle of any of clauses 16 to 26, wherein the second V2X-capable vehicle is blocked from view of perception sensors of the first V2X-capable vehicle.

Clause 28. The first V2X-capable vehicle of clause 27, wherein the perception sensors of the first V2X-capable vehicle comprise: one or more radar sensors, a lidar sensor, one or more cameras, or any combination thereof.

Clause 29. The first V2X-capable vehicle of any of clauses 16 to 28, wherein the one or more V2X messages are one or more basic safety messages (BSMs).

Clause 30. The first V2X-capable vehicle of any of clauses 16 to 29, wherein the one or more processors, either alone or in combination, are further configured to: perform a driving maneuver according to the viable driving trajectory.

Clause 31. A first vehicle-to-everything (V2X)-capable vehicle, comprising: means for receiving, from a second V2X-capable vehicle, one or more V2X messages indicating a driving state of the second V2X-capable vehicle, wherein the driving state comprises a location of the second V2X-capable vehicle, a speed of the second V2X-capable vehicle, a heading of the second V2X vehicle, or any combination thereof; and means for determining a viable driving trajectory for the first V2X-capable vehicle from a plurality of potential driving trajectories of the first V2X-capable vehicle based, at least in part, on the driving state of the second V2X-capable vehicle.

Clause 32. The first V2X-capable vehicle of clause 31, wherein the means for determining the viable driving trajectory comprises: means for determining non-viable driving trajectories of the plurality of potential driving trajectories based, at least in part, on the driving state of the second V2X-capable vehicle; and means for removing the non-viable driving trajectories from the plurality of potential driving trajectories to determine a set of remaining driving trajectories of the plurality of potential driving trajectories, wherein the viable driving trajectory for the first V2X-capable vehicle is a remaining driving trajectory of the set of remaining driving trajectories.

Clause 33. The first V2X-capable vehicle of clause 32, further comprising: means for transmitting the set of remaining driving trajectories to one or more other V2X-capable vehicles, roadside infrastructure, or any combination thereof.

Clause 34. The first V2X-capable vehicle of any of clauses 31 to 33, wherein the means for determining the viable driving trajectory comprises: means for determining non-viable driving trajectories of the plurality of potential driving trajectories based, at least in part, on the driving state of the second V2X-capable vehicle; and means for reallocating nodes from the non-viable driving trajectories to remaining driving trajectories of the plurality of potential driving trajectories, wherein the viable driving trajectory for the first V2X-capable vehicle is a remaining driving trajectory of the plurality of potential driving trajectories, wherein each node represents a position on a potential driving trajectory through a macro action of one or more macro actions, and wherein each macro action represents a portion of a lane of a road on which the first V2X-capable vehicle is travelling.

Clause 35. The first V2X-capable vehicle of any of clauses 31 to 34, wherein the means for determining the viable driving trajectory comprises: means for building a search tree of the plurality of potential driving trajectories, wherein each of the plurality of potential driving trajectories corresponds to a subtree of the search tree.

Clause 36. The first V2X-capable vehicle of clause 35, wherein: each subtree of the search tree comprises one or more macro actions, each macro action represents a portion of a lane of a road on which the first V2X-capable vehicle is travelling and is associated with one or more nodes, and each node represents a position on a potential driving trajectory through the portion of the lane of the road represented by the corresponding macro action.

Clause 37. The first V2X-capable vehicle of any of clauses 35 to 36, wherein the means for determining the viable driving trajectory comprises: means for determining subtrees of the search tree corresponding to non-viable driving trajectories of the plurality of potential driving trajectories based, at least in part, on the driving state of the second V2X-capable vehicle; and means for removing the subtrees of the search tree corresponding to the non-viable driving trajectories from the plurality of potential driving trajectories, wherein the viable driving trajectory for the first V2X-capable vehicle corresponds to a remaining subtree of the search tree.

Clause 38. The first V2X-capable vehicle of clause 37, further comprising: means for transmitting remaining subtrees of the search tree to one or more other V2X-capable vehicles, roadside infrastructure, or any combination thereof.

Clause 39. The first V2X-capable vehicle of any of clauses 35 to 38, wherein the means for determining the viable driving trajectory comprises: means for determining subtrees of the search tree corresponding to non-viable driving trajectories of the plurality of potential driving trajectories based, at least in part, on the driving state of the second V2X-capable vehicle; and means for reallocating nodes from the subtrees of the search tree corresponding to the non-viable driving trajectories to remaining subtrees of the search tree, wherein the viable driving trajectory for the first V2X-capable vehicle corresponds to a remaining subtree of the search tree, wherein each node represents a position on a potential driving trajectory through a macro action of one or more macro actions, and wherein each macro action represents a portion of a lane of a road on which the first V2X-capable vehicle is travelling.

Clause 40. The first V2X-capable vehicle of any of clauses 35 to 39, wherein the search tree comprises a Monte Carlo Tree Search.

Clause 41. The first V2X-capable vehicle of any of clauses 31 to 40, further comprising: means for transmitting the viable driving trajectory to one or more other V2X-capable vehicles, roadside infrastructure, or any combination thereof; means for receiving one or more driving trajectories from the one or more other V2X-capable vehicles, the roadside infrastructure, or any combination thereof, wherein the viable driving trajectory is determined further based on the one or more driving trajectories; or any combination thereof.

Clause 42. The first V2X-capable vehicle of any of clauses 31 to 41, wherein the second V2X-capable vehicle is blocked from view of perception sensors of the first V2X-capable vehicle.

Clause 43. The first V2X-capable vehicle of clause 42, wherein the perception sensors of the first V2X-capable vehicle comprise: one or more radar sensors, a lidar sensor, one or more cameras, or any combination thereof.

Clause 44. The first V2X-capable vehicle of any of clauses 31 to 43, wherein the one or more V2X messages are one or more basic safety messages (BSMs).

Clause 45. The first V2X-capable vehicle of any of clauses 31 to 44, further comprising: means for performing a driving maneuver according to the viable driving trajectory.

Clause 46. A non-transitory computer-readable medium storing computer-executable instructions that, when executed by a first vehicle-to-everything (V2X)-capable vehicle, cause the first V2X-capable vehicle to: receive, from a second V2X-capable vehicle, one or more V2X messages indicating a driving state of the second V2X-capable vehicle, wherein the driving state comprises a location of the second V2X-capable vehicle, a speed of the second V2X-capable vehicle, a heading of the second V2X vehicle, or any combination thereof; and determine a viable driving trajectory for the first V2X-capable vehicle from a plurality of potential driving trajectories of the first V2X-capable vehicle based, at least in part, on the driving state of the second V2X-capable vehicle.

Clause 47. The non-transitory computer-readable medium of clause 46, wherein the computer-executable instructions that, when executed by the first V2X-capable vehicle, cause the first V2X-capable vehicle to determine the viable driving trajectory comprise computer-executable instructions that, when executed by the first V2X-capable vehicle, cause the first V2X-capable vehicle to: determine non-viable driving trajectories of the plurality of potential driving trajectories based, at least in part, on the driving state of the second V2X-capable vehicle; and remove the non-viable driving trajectories from the plurality of potential driving trajectories to determine a set of remaining driving trajectories of the plurality of potential driving trajectories, wherein the viable driving trajectory for the first V2X-capable vehicle is a remaining driving trajectory of the set of remaining driving trajectories.

Clause 48. The non-transitory computer-readable medium of clause 47, further comprising computer-executable instructions that, when executed by the first V2X-capable vehicle, cause the first V2X-capable vehicle to: transmit the set of remaining driving trajectories to one or more other V2X-capable vehicles, roadside infrastructure, or any combination thereof.

Clause 49. The non-transitory computer-readable medium of any of clauses 46 to 48, wherein the computer-executable instructions that, when executed by the first V2X-capable vehicle, cause the first V2X-capable vehicle to determine the viable driving trajectory comprise computer-executable instructions that, when executed by the first V2X-capable vehicle, cause the first V2X-capable vehicle to: determine non-viable driving trajectories of the plurality of potential driving trajectories based, at least in part, on the driving state of the second V2X-capable vehicle; and reallocate nodes from the non-viable driving trajectories to remaining driving trajectories of the plurality of potential driving trajectories, wherein the viable driving trajectory for the first V2X-capable vehicle is a remaining driving trajectory of the plurality of potential driving trajectories, wherein each node represents a position on a potential driving trajectory through a macro action of one or more macro actions, and wherein each macro action represents a portion of a lane of a road on which the first V2X-capable vehicle is travelling.

Clause 50. The non-transitory computer-readable medium of any of clauses 46 to 49, wherein the computer-executable instructions that, when executed by the first V2X-capable vehicle, cause the first V2X-capable vehicle to determine the viable driving trajectory comprise computer-executable instructions that, when executed by the first V2X-capable vehicle, cause the first V2X-capable vehicle to: build a search tree of the plurality of potential driving trajectories, wherein each of the plurality of potential driving trajectories corresponds to a subtree of the search tree.

Clause 51. The non-transitory computer-readable medium of clause 50, wherein: each subtree of the search tree comprises one or more macro actions, each macro action represents a portion of a lane of a road on which the first V2X-capable vehicle is travelling and is associated with one or more nodes, and each node represents a position on a potential driving trajectory through the portion of the lane of the road represented by the corresponding macro action.

Clause 52. The non-transitory computer-readable medium of any of clauses 50 to 51, wherein the computer-executable instructions that, when executed by the first V2X-capable vehicle, cause the first V2X-capable vehicle to determine the viable driving trajectory comprise computer-executable instructions that, when executed by the first V2X-capable vehicle, cause the first V2X-capable vehicle to: determine subtrees of the search tree corresponding to non-viable driving trajectories of the plurality of potential driving trajectories based, at least in part, on the driving state of the second V2X-capable vehicle; and remove the subtrees of the search tree corresponding to the non-viable driving trajectories from the plurality of potential driving trajectories, wherein the viable driving trajectory for the first V2X-capable vehicle corresponds to a remaining subtree of the search tree.

Clause 53. The non-transitory computer-readable medium of clause 52, further comprising computer-executable instructions that, when executed by the first V2X-capable vehicle, cause the first V2X-capable vehicle to: transmit remaining subtrees of the search tree to one or more other V2X-capable vehicles, roadside infrastructure, or any combination thereof.

Clause 54. The non-transitory computer-readable medium of any of clauses 50 to 53, wherein the computer-executable instructions that, when executed by the first V2X-capable vehicle, cause the first V2X-capable vehicle to determine the viable driving trajectory comprise computer-executable instructions that, when executed by the first V2X-capable vehicle, cause the first V2X-capable vehicle to: determine subtrees of the search tree corresponding to non-viable driving trajectories of the plurality of potential driving trajectories based, at least in part, on the driving state of the second V2X-capable vehicle; and reallocate nodes from the subtrees of the search tree corresponding to the non-viable driving trajectories to remaining subtrees of the search tree, wherein the viable driving trajectory for the first V2X-capable vehicle corresponds to a remaining subtree of the search tree, wherein each node represents a position on a potential driving trajectory through a macro action of one or more macro actions, and wherein each macro action represents a portion of a lane of a road on which the first V2X-capable vehicle is travelling.

Clause 55. The non-transitory computer-readable medium of any of clauses 50 to 54, wherein the search tree comprises a Monte Carlo Tree Search.

Clause 56. The non-transitory computer-readable medium of any of clauses 46 to 55, further comprising computer-executable instructions that, when executed by the first V2X-capable vehicle, cause the first V2X-capable vehicle to: transmit the viable driving trajectory to one or more other V2X-capable vehicles, roadside infrastructure, or any combination thereof; receive one or more driving trajectories from the one or more other V2X-capable vehicles, the roadside infrastructure, or any combination thereof, wherein the viable driving trajectory is determined further based on the one or more driving trajectories; or any combination thereof.

Clause 57. The non-transitory computer-readable medium of any of clauses 46 to 56, wherein the second V2X-capable vehicle is blocked from view of perception sensors of the first V2X-capable vehicle.

Clause 58. The non-transitory computer-readable medium of clause 57, wherein the perception sensors of the first V2X-capable vehicle comprise: one or more radar sensors, a lidar sensor, one or more cameras, or any combination thereof.

Clause 59. The non-transitory computer-readable medium of any of clauses 46 to 58, wherein the one or more V2X messages are one or more basic safety messages (BSMs).

Clause 60. The non-transitory computer-readable medium of any of clauses 46 to 59, further comprising computer-executable instructions that, when executed by the first V2X-capable vehicle, cause the first V2X-capable vehicle to: perform a driving maneuver according to the viable driving trajectory.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programmable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A method of wireless communication performed by a first vehicle-to-everything (V2X)-capable vehicle, comprising:
receiving, from a second V2X-capable vehicle, one or more V2X messages indicating a driving state of the second V2X-capable vehicle, wherein the driving state comprises a location of the second V2X-capable vehicle, a speed of the second V2X-capable vehicle, a heading of the second V2X vehicle, or any combination thereof; and
determining a viable driving trajectory for the first V2X-capable vehicle from a plurality of potential driving trajectories of the first V2X-capable vehicle based, at least in part, on the driving state of the second V2X-capable vehicle.

2. The method of claim 1, wherein determining the viable driving trajectory comprises:
determining non-viable driving trajectories of the plurality of potential driving trajectories based, at least in part, on the driving state of the second V2X-capable vehicle; and
removing the non-viable driving trajectories from the plurality of potential driving trajectories to determine a set of remaining driving trajectories of the plurality of potential driving trajectories, wherein the viable driving trajectory for the first V2X-capable vehicle is a remaining driving trajectory of the set of remaining driving trajectories.

3. The method of claim 2, further comprising:
transmitting the set of remaining driving trajectories to one or more other V2X-capable vehicles, roadside infrastructure, or any combination thereof.

4. The method of claim 1, wherein determining the viable driving trajectory comprises:
determining non-viable driving trajectories of the plurality of potential driving trajectories based, at least in part, on the driving state of the second V2X-capable vehicle; and
reallocating nodes from the non-viable driving trajectories to remaining driving trajectories of the plurality of potential driving trajectories,
wherein the viable driving trajectory for the first V2X-capable vehicle is a remaining driving trajectory of the plurality of potential driving trajectories,
wherein each node represents a position on a potential driving trajectory through a macro action of one or more macro actions, and
wherein each macro action represents a portion of a lane of a road on which the first V2X-capable vehicle is travelling.

5. The method of claim 1, wherein determining the viable driving trajectory comprises:
building a search tree of the plurality of potential driving trajectories, wherein each of the plurality of potential driving trajectories corresponds to a subtree of the search tree.

6. The method of claim 5, wherein:
each subtree of the search tree comprises one or more macro actions,
each macro action represents a portion of a lane of a road on which the first V2X-capable vehicle is travelling and is associated with one or more nodes, and
each node represents a position on a potential driving trajectory through the portion of the lane of the road represented by the corresponding macro action.

7. The method of claim 5, wherein determining the viable driving trajectory comprises:
determining subtrees of the search tree corresponding to non-viable driving trajectories of the plurality of potential driving trajectories based, at least in part, on the driving state of the second V2X-capable vehicle; and
removing the subtrees of the search tree corresponding to the non-viable driving trajectories from the plurality of potential driving trajectories, wherein the viable driving trajectory for the first V2X-capable vehicle corresponds to a remaining subtree of the search tree.

8. The method of claim 7, further comprising:
transmitting remaining subtrees of the search tree to one or more other V2X-capable vehicles, roadside infrastructure, or any combination thereof.

9. The method of claim 5, wherein determining the viable driving trajectory comprises:
determining subtrees of the search tree corresponding to non-viable driving trajectories of the plurality of potential driving trajectories based, at least in part, on the driving state of the second V2X-capable vehicle; and
reallocating nodes from the subtrees of the search tree corresponding to the non-viable driving trajectories to remaining subtrees of the search tree,
wherein the viable driving trajectory for the first V2X-capable vehicle corresponds to a remaining subtree of the search tree,
wherein each node represents a position on a potential driving trajectory through a macro action of one or more macro actions, and
wherein each macro action represents a portion of a lane of a road on which the first V2X-capable vehicle is travelling.

10. The method of claim 5, wherein the search tree comprises a Monte Carlo Tree Search.

11. The method of claim 1, further comprising:
transmitting the viable driving trajectory to one or more other V2X-capable vehicles, roadside infrastructure, or any combination thereof;
receiving one or more driving trajectories from the one or more other V2X-capable vehicles, the roadside infrastructure, or any combination thereof, wherein the viable driving trajectory is determined further based on the one or more driving trajectories; or
any combination thereof.

12. The method of claim 1, wherein the second V2X-capable vehicle is blocked from view of perception sensors of the first V2X-capable vehicle.

13. The method of claim 12, wherein the perception sensors of the first V2X-capable vehicle comprise:
one or more radar sensors,
a lidar sensor,
one or more cameras, or
any combination thereof.

14. The method of claim 1, wherein the one or more V2X messages are one or more basic safety messages (BSMs).

15. The method of claim 1, further comprising:
performing a driving maneuver according to the viable driving trajectory.

16. A first vehicle-to-everything (V2X)-capable vehicle, comprising:
one or more memories;
one or more transceivers; and
one or more processors communicatively coupled to the one or more memories and the one or more transceivers, the one or more processors, either alone or in combination, configured to:
receive, via the one or more transceivers, from a second V2X-capable vehicle, one or more V2X messages indicating a driving state of the second V2X-capable vehicle, wherein the driving state comprises a location of the second V2X-capable vehicle, a speed of the second V2X-capable vehicle, a heading of the second V2X vehicle, or any combination thereof; and
determine a viable driving trajectory for the first V2X-capable vehicle from a plurality of potential driving trajectories of the first V2X-capable vehicle based, at least in part, on the driving state of the second V2X-capable vehicle.

17. The first V2X-capable vehicle of claim 16, wherein the one or more processors configured to determine the viable driving trajectory comprises the one or more processors, either alone or in combination, configured to:
determine non-viable driving trajectories of the plurality of potential driving trajectories based, at least in part, on the driving state of the second V2X-capable vehicle; and
remove the non-viable driving trajectories from the plurality of potential driving trajectories to determine a set of remaining driving trajectories of the plurality of potential driving trajectories, wherein the viable driving trajectory for the first V2X-capable vehicle is a remaining driving trajectory of the set of remaining driving trajectories.

18. The first V2X-capable vehicle of claim 17, wherein the one or more processors, either alone or in combination, are further configured to:
transmit, via the one or more transceivers, the set of remaining driving trajectories to one or more other V2X-capable vehicles, roadside infrastructure, or any combination thereof.

19. The first V2X-capable vehicle of claim 16, wherein the one or more processors configured to determine the viable driving trajectory comprises the one or more processors, either alone or in combination, configured to:
determine non-viable driving trajectories of the plurality of potential driving trajectories based, at least in part, on the driving state of the second V2X-capable vehicle; and
reallocate nodes from the non-viable driving trajectories to remaining driving trajectories of the plurality of potential driving trajectories,
wherein the viable driving trajectory for the first V2X-capable vehicle is a remaining driving trajectory of the plurality of potential driving trajectories,
wherein each node represents a position on a potential driving trajectory through a macro action of one or more macro actions, and
wherein each macro action represents a portion of a lane of a road on which the first V2X-capable vehicle is travelling.

20. The first V2X-capable vehicle of claim 16, wherein the one or more processors configured to determine the viable driving trajectory comprises the one or more processors, either alone or in combination, configured to:
build a search tree of the plurality of potential driving trajectories, wherein each of the plurality of potential driving trajectories corresponds to a subtree of the search tree.

21. The first V2X-capable vehicle of claim 20, wherein:
each subtree of the search tree comprises one or more macro actions,
each macro action represents a portion of a lane of a road on which the first V2X-capable vehicle is travelling and is associated with one or more nodes, and
each node represents a position on a potential driving trajectory through the portion of the lane of the road represented by the corresponding macro action.

22. The first V2X-capable vehicle of claim 20, wherein the one or more processors configured to determine the viable driving trajectory comprises the one or more processors, either alone or in combination, configured to:
determine subtrees of the search tree corresponding to non-viable driving trajectories of the plurality of potential driving trajectories based, at least in part, on the driving state of the second V2X-capable vehicle; and
remove the subtrees of the search tree corresponding to the non-viable driving trajectories from the plurality of potential driving trajectories, wherein the viable driving trajectory for the first V2X-capable vehicle corresponds to a remaining subtree of the search tree.

23. The first V2X-capable vehicle of claim 22, wherein the one or more processors, either alone or in combination, are further configured to:
transmit, via the one or more transceivers, remaining subtrees of the search tree to one or more other V2X-capable vehicles, roadside infrastructure, or any combination thereof.

24. The first V2X-capable vehicle of claim 20, wherein the one or more processors configured to determine the viable driving trajectory comprises the one or more processors, either alone or in combination, configured to:
determine subtrees of the search tree corresponding to non-viable driving trajectories of the plurality of potential driving trajectories based, at least in part, on the driving state of the second V2X-capable vehicle; and
reallocate nodes from the subtrees of the search tree corresponding to the non-viable driving trajectories to remaining subtrees of the search tree,
wherein the viable driving trajectory for the first V2X-capable vehicle corresponds to a remaining subtree of the search tree,
wherein each node represents a position on a potential driving trajectory through a macro action of one or more macro actions, and
wherein each macro action represents a portion of a lane of a road on which the first V2X-capable vehicle is travelling.

25. The first V2X-capable vehicle of claim 20, wherein the search tree comprises a Monte Carlo Tree Search.

26. The first V2X-capable vehicle of claim 16, wherein the one or more processors, either alone or in combination, are further configured to:
transmit, via the one or more transceivers, the viable driving trajectory to one or more other V2X-capable vehicles, roadside infrastructure, or any combination thereof;
receive, via the one or more transceivers, one or more driving trajectories from the one or more other V2X-capable vehicles, the roadside infrastructure, or any combination thereof, wherein the viable driving trajectory is determined further based on the one or more driving trajectories; or
any combination thereof.

27. The first V2X-capable vehicle of claim 16, wherein the second V2X-capable vehicle is blocked from view of perception sensors of the first V2X-capable vehicle.

28. The first V2X-capable vehicle of claim 27, wherein the perception sensors of the first V2X-capable vehicle comprise:
one or more radar sensors,
a lidar sensor,
one or more cameras, or
any combination thereof.

29. The first V2X-capable vehicle of claim 16, wherein the one or more V2X messages are one or more basic safety messages (BSMs).

30. The first V2X-capable vehicle of claim 16, wherein the one or more processors, either alone or in combination, are further configured to:
perform a driving maneuver according to the viable driving trajectory.

31. A first vehicle-to-everything (V2X)-capable vehicle, comprising:
means for receiving, from a second V2X-capable vehicle, one or more V2X messages indicating a driving state of the second V2X-capable vehicle, wherein the driving state comprises a location of the second V2X-capable vehicle, a speed of the second V2X-capable vehicle, a heading of the second V2X vehicle, or any combination thereof; and
means for determining a viable driving trajectory for the first V2X-capable vehicle from a plurality of potential driving trajectories of the first V2X-capable vehicle based, at least in part, on the driving state of the second V2X-capable vehicle.

32. A non-transitory computer-readable medium storing computer-executable instructions that, when executed by a first vehicle-to-everything (V2X)-capable vehicle, cause the first V2X-capable vehicle to:
receive, from a second V2X-capable vehicle, one or more V2X messages indicating a driving state of the second V2X-capable vehicle, wherein the driving state comprises a location of the second V2X-capable vehicle, a speed of the second V2X-capable vehicle, a heading of the second V2X vehicle, or any combination thereof; and
determine a viable driving trajectory for the first V2X-capable vehicle from a plurality of potential driving trajectories of the first V2X-capable vehicle based, at least in part, on the driving state of the second V2X-capable vehicle.
